(19) United States
(12) Patent Application Publication
(10) Pub. No.: US 2009/0106298 A1
(43) Pub. Date: Apr. 23, 2009

(54) INFORMATION PROCESSING METHOD, INFORMATION PROCESSING DEVICE, AND INFORMATION PROCESSING PROGRAM

(75) Inventor: Shinji Furusho, Kanagawa (JP)

Correspondence Address: GRIFFIN & SZIPL, PC, SUITE PH-1, 2300 NINTH STREET, SOUTH, ARLINGTON, VA, 22204, US

(73) Assignee: TURBO DATA LABORATORIES , INC., Kanagawa (JP)

(21) Appl. No.: 12/063,596

(22) PCT Filed: Aug. 9, 2006
(86) PCT No.: PCT/JP2006/315739

§ 371 Date: Feb. 12, 2008

(30) Foreign Application Priority Data
Aug. 12, 2005 (JP) 2005-234464

(51) Int. Cl. G06F 17/30

(52) U.S. Cl. 707/102; 707/E17.009

(57) ABSTRACT

A partial tree is efficiently removed from a tree, or another tree is inserted into a tree. A flag is set for the node identifier of a node constituting a partial tree to be removed in an erasure flag array. Referencing the value of the erasure flag array, node identifiers which are consecutive integers given to the nodes while giving precedence to the nodes in the same generation over the child nodes are given to the nodes in the tree from which the partial tree has been removed. The given node identifiers are associated with those of the nodes in the tree before the partial tree is removed and stored in a new node identifier array, which is stored in a storage device. According to a parent-child relation definition array and the node identifier array, the parent-child definition array of the tree from which the partial tree is removed where the node identifiers of the parent node of the nodes having the node identifiers are stored in association with the new node identifiers is stored in the storage device.

### TECHNICAL FIELD

The present invention relates to a method of handling a tree data structure and, more specifically, to a method of deleting a subtree from a tree, a method of inserting one tree insertion into another tree, and an information processing device that performs these methods, and a program for causing a computer to execute these methods.

### BACKGROUND ART

A database has been used for various types of applications, and in mid-size and large-size systems, mainly used is a relational database (RDB) that can eliminate any logical contradiction. For example, the RDB has been used for a system of seat reservations for airlines. In this case, through specification of key items, a rapid search is enabled for finding of (most of the time a single) target, or reservation confirmation, cancel, or change can be made. Moreover, because the number of seats available for each flight is at most a few hundred, the number of vacant seats can be also found for a specific air flight.

Such an RDB is known as being suited for handling of table-form data, but not being suited for handling of tree-form data (as an example, refer to Non-Patent Document 1).

Further, among applications, some are suited more for representation in tree form than representation in table form. Especially, in recent years, as data standard for applications of the Intranet and the Internet, XML using a tree data structure has been popularized (for details of XML, refer to Non-Patent Document 2, for example).

However, handling of the tree data structure, e.g., search of tree-form data, is generally of very poor efficiency. The primary reason of such poor efficiency is that data is scattered all over the nodes, thereby resulting in a difficulty in specifying at once the location where the data is supposed to be. With the RDB, for example, data about “age” is stored only in an item of “age” in a specific table. However, with the tree data structure, nodes storing data of “age” are scattered at random. Therefore, generally, no search can be made for any right data unless the tree data structure is checked in its entirety.

The second reason of such poor efficiency is that representing the search result takes a long time. Representing a group of nodes hit by a search often requires to represent also descendant nodes of each of the nodes. However, because the data structure thereof is not fixed in format unlike an RDBMS, it takes a long time to represent such descendant nodes.

In consideration thereof, for making full use of the advantages of the RDB having been mainly used as a database, previously proposed is a method of, for compiling the tree data structure into a database, compiling tree-form data into an RDB (as an example, refer to Patent Document 1). With the RDB, the data is broken up into the form of table (list) and then stored. As such, for compiling the actual tree-form data into an RDB, there needs to shoehorn the tree-form data into the table. However, for handling the tree data structure varying in type, there needs to shoehorn the data into the table individually on a structure basis for system design. Therefore, the system construction based on the RDB is a very troublesome work.

Whereas, proposed is a method of compiling tree-form data, especially XML data, as it is into a database. With the tree data structure, various types of representation are possible because one node can be accompanied by a descendant node(s), thereby being able to considerably reduce the trouble of system design. Accordingly, with the technology of handling the tree structure such as XML as a core, the needs for processing the tree-form data has been increased.

As an exemplary approach for a method of compiling XML data as it is into a database, a copy of data written in the tree structure is extracted, and in case of an item of “age”, for example, index data for a search of “age” is separately stored (as an example, refer to Patent Document 2). This enables to make full use of merits of XML data, i.e., data itself can be added with attributes, and to store any relational structure of items represented using tags.

Moreover, an interface has been disclosed for an object model called DOM for use to expand an XML document on a memory with the tree structure (as an example, refer to Non-Patent Document 3).

### [Patent Document 1] JP-A-2003-248615

### [Patent Document 2] JP-A-2001-195406

[Non-Patent Document 1] Systems Engineering Consultants. Co., Ltd., “Karearea White Paper”, [online], [Search on Feb. 19, 2004], the Internet <URL: http://www.sec.co.jp/products/karearea/>
[Non-Patent Document 2] W3C, “Extensible Markup Language (XML) 1.0 (Third Edition)”, [online], Feb. 4, 2004, [Search on Feb. 19, 2004], the Internet <URL: http://www.w3.org/TR/2004/REC-xml-20040204/>

### [Non-Patent Document 3] R. Wyke Allen, Brad Loupen, Sultan Rehman, “Programming XML”, Nikkei DP Soft Press, Inc., 2002, pp 59-84

### DISCLOSURE OF THE INVENTION

### Problems that the Invention is to Solve

The problem is that, with such an approach as to separately store the index data for a search use, the data is stored at least duplicate, and the cost is required for creating an index and a data area is required for storing the resulting index. This is considered disadvantageous in terms of storing large size data.

With such a mechanism, even if a search is actually made and any node is specified, representing the node takes a long time. Moreover, this mechanism cannot be available for a search that matters the relationship among the nodes (e.g., for extraction of a tree including an “age” of “60 years old” for an ancestor node, and an “age” of “1 year old” for a descendant node).

Such fundamental problems of the previous technology lie in that the tree data structure is represented by paying attention only to individual data, and connecting nodes each storing data by means of pointers. As a result, the relationship among the data, e.g., the relationship such as parent and child relationship, ancestor-descendent relationship, sibling relationship, and generational relationship, cannot be traced with efficiency. In other words, the pointer is not fixed in value, and thus can be used only for an application of indicating the storage address of the data, thereby not being able to directly represent the relationship among the nodes. This resultantly causes, with the previous technology, a difficulty in editing the topology of the tree-form structure, especially in inserting any descendent node into nodes in form of a tree structure data. Moreover, the DOM above serves only for defining an operational interface for editing the topology of the tree data structure, and does not serve for defining any specific technique for such an operation.

It is thus an object of the present invention to provide a method, an information processing device and program for efficiently deleting from a tree a subtree being a part of the tree, and inserting one tree into another tree.

### Means for Solving the Problems

In order to achieve the above object, the present invention implements such insertion and deletion using a parent-child relationship definition array in which the parent-child relationship among nodes configuring a tree data structure is not represented by a “parent→child” relationship, which associates a child node with a parent node, but is represented by a “child→parent” relationship, which associates a parent node with a child node.

When the parent-child relationship is represented by the “parent→child” relationship known in the art, there may be a case where a plurality of child nodes correspond to a single parent node. As such, the parent-child relationship cannot be defined unless two elements of a parent node and a child node are specified. That is, even if a parent node is specified, a child node under the parent-child relationship with the parent node cannot be specified. On the other hand, as in the present invention, when the parent-child relationship is represented by the “child→parent” relationship, each child node never fails to have its only own parent node. As such, by specifying a child node, its only own parent node corresponding to the child node can be specified at once.

More in detail, the object of the present invention is achieved by an information processing method of deleting a subtree including a vertex node, which is a specific node, and descendant nodes of the vertex node, from an original tree and generating a parent-child relationship definition array describing a tree data structure of a resultant tree from which the subtree has been deleted in a storage device in an information processing device having a parent-child relationship definition array describing a tree data structure of the original tree generated and stored in the storage device, in which the parent-child relationship definition array contains node identifiers assigned to parent nodes of respective non-root nodes in association with node identifiers assigned to the non-root nodes, the node identifiers being consecutive integers, which are assigned to nodes including a root node and satisfy a condition such that a node identifier of a parent node is smaller than a node identifier of its child node, and the non-root nodes being nodes other than the root node, characterized in that the method comprising the steps of:

reading out from the storage device the parent-child relationship definition array for the original tree from which the subtree is to be deleted;

setting flags for the node identifiers forming the subtree in a deletion-flag array having the same size as the parent-child relationship definition array for the original tree and being generated and stored in the memory device by referring to the node identifier of the vertex node located closest to the root node in the subtree and the parent-child relationship definition array for the original tree;

assigning new node identifiers to respective nodes in the resultant tree from which the subtree has been deleted such that a parent node and its child node satisfy the condition that a node identifier of the parent node is smaller than that of its child node by referring to the deletion-flag array, and generating a new node identifier array in the storage device, the new node identifier array containing the assigned new node identifiers in association with the node identifiers of the nodes for the original tree; and

generating the parent-child relationship array for the resultant tree in the storage device based on the parent-child relationship definition array for the original tree and the new node identifier array, wherein the parent-child relationship array for the resultant tree contains node identifiers of parent nodes of respective nodes having the assigned new node identifiers in association with the assigned new identifiers.

In a preferred embodiment, the node identifiers are consecutive integers which are assigned to the nodes with a higher priority to nodes of same generation over child nodes, and the parent-child relationship array containing the node identifiers assigned to the parent nodes of the respective non-root nodes in association with the node identifiers assigned to the non-root nodes excluding the root node is stored in the storage device, and

the step of generating the new node identifier array comprises a step of assigning the node identifier to each of the nodes, wherein the node identifier is a consecutive integer assigned to each of the nodes with the higher priority to the nodes of the same generation over the child nodes.

Alternatively, the node identifier may be consecutive integers which are assigned to the nodes with a higher priority to child nodes over nodes of same generation, and the parent-child relationship array containing the node identifiers assigned to the parent nodes of the respective non-root nodes in association with the node identifiers assigned to the non-root nodes excluding the root node may be stored in the storage device, and

the step of generating the new node identifier array comprises a step of assigning the node identifier to each of the nodes, wherein the node identifier is a consecutive integer assigned to each of the nodes with the higher priority to the child nodes over the nodes of the same generation.

Also in a preferred embodiment, a node value storage array is stored in the storage device, wherein the node value storage array contains at least a node value for the node of the original tree in association with each of the node identifiers for the nodes of the original tree, and

the method further comprises a step of updating the node value storage array in accordance with a correlation between original node identifiers and the new node identifiers by referring to the new node identifier array.

Also in another preferred embodiment, a node value storage array is stored in the storage device stores, wherein the node storage array contains at least a node value for the node of the original tree in association with each of the node identifiers for the nodes of the original tree, and

the method further comprises a step of generating a new node value storage array by referring to the new node identifier array, wherein the new node value storage array containing the node values in association with the respective new node identifiers in accordance with a correlation between original node identifiers and the new node identifiers.

Also in a more preferred embodiment, the step of generating the new node identifier array comprises the steps of:

reserving an area for the new node identifier array of the same size as that of the parent-child relationship definition array in the storage device;

reserving a current node identifier area in the storage device, the area temporarily storing the new node identifier, and setting an initial value to the current node identifier area; and

setting a value stored in the current node identifier area to the new node identifier array if it is determined that a flag in the deletion-flag array is not set by referring to the deletion-flag array and then incrementing the value in the current node identifier area, or otherwise setting an invalid value to the new node identifier array if it is determined that a flag in the deletion-flag array is set.

Also in another preferred embodiment, the step of generating the parent-child relationship definition array after deleting the subtree comprises the steps of:

reserving an area for a storage address array of a same size as that of the parent-child relationship definition array in the storage device;

setting the value in the new node identifier array to the storage address array unless it is determined a value located at a storage location in the new node identifier array is the invalid value by referring to the value, the storage location being the same as that of a value in the parent-child relationship definition array;

reserving an area for a parent node identifier array of the same size as that of the parent-child relationship definition array in the storage device;

setting a value in the new node identifier array to the parent node identifier array at the same location as that of a value in the parent-child relationship definition array by referring to the value in the new node identifier array at a location indicated by the value in the parent-child relationship definition array; and

generating the parent-child relationship definition array for that resultant tree, the array containing the value from the parent node identifier array in association with the value in the storage address array.

Moreover, the object of the present invention is achieved by an information processing method of adding a received-side tree to a receiving-side tree by connecting a root node in the received-type tree to a specific node in the receiving-type tree, and generating a parent-child relationship definition array describing a tree data structure of a resultant tree after the received-type tree has been inserted into the receiving-type tree in a storage device in an information processing device having a parent-child relationship definition array describing a tree data structure of a tree generated and stored in the storage device, in which the parent-child relationship definition array contains node identifiers assigned to parent nodes of respective non-root nodes in association with node identifiers assigned to the non-root nodes, the node identifiers being consecutive integers assigned to nodes including a root node with a higher priority to nodes of same generation over child nodes, and the non-root nodes being nodes other than the root node, characterized in that the method comprising the steps of:

reading out from the storage device a first parent-child relationship definition array for the receiving-side tree and a second parent-child relationship definition array for the received-side tree;

specifying a node in the receiving-side tree adjacent to each node in the received-type tree based on information concerning a position where a vertex node is to be inserted, the vertex node corresponding to the root node in the received-side tree and being located closest to a root node in a subtree included in the receiving-side tree, and storing information concerning the node in the receiving-side tree in the storage device;

assigning a new node identifier to each of nodes in the receiving-side after insertion of the received-side tree by referring to the information concerning the node in the receiving-side tree, the new node identifier being a consecutive integer assigned to the node with a higher priority to nodes of same generation over child nodes, and generating a first new node identifier array in the storage device, the first new node identifier containing the assigned new node identifier in association with the node identifier for the node in the receiving-side tree before insertion of the received-side tree, and, at the same time, assigning a new node identifier to each of nodes in the received-side tree after insertion of the received-side tree based on the information concerning the position where the vertex node in the received-side tree is to be inserted, the node identifier being a consecutive integer assigned to the node with a higher priority to nodes of same generation over child nodes, and generating a second new node identifier array in the storage device, the second new node identifier array containing the assigned new node identifiers in association with the node identifier for the node in the received-side tree before insertion of the received-side tree; and

generating the parent-child relationship definition array for the resultant tree after insertion of the received-type tree in the storage device based on the first and second parent-child relationship definition arrays and the first and second new node identifier arrays, the parent-child relationship definition array for the resultant tree containing a node identifier for a parent node of its child node assigned the new node identifier in association with the new node identifiers.

In a preferred embodiment, a first node value storage array and a second node value storage array are stored in the storage device, the first node value storage array containing at least a node value of a node in the receiving-side tree in association with each node identifier for the node in the receiving-side tree and the second node value storage array containing at least a node value of a node in the received-side tree in association with each node identifier for the node in the received-side tree, and

the method further comprises a step of updating at least one of the first and second node value storage arrays in accordance with a correlation between original node identifiers assigned to nodes in the receiving-side tree and the received-side tree and new node identifiers assigned to nodes after insertion by referring to the first and second new node identifier arrays.

In another preferred embodiment, a first node value storage array and a second node value storage array are stored in the storage device, the first node value storage array containing at least a node value of a node in the receiving-side tree in association with each node identifier for the node in the receiving-side tree and the second node value storage array containing at least a node value of a node in the received-side tree in association with each node identifier for the node in the received-side tree, and

the method further comprising a step of generating a new node value storage array by referring to the first and second new node identifier arrays, wherein the new node value storage array containing the node value in association with each of the new node identifiers in accordance with a correlation between original node identifiers assigned to nodes in the receiving-side tree and the received-side tree and new node identifiers assigned to nodes after insertion.

In a more preferred embodiment, the step of storing information concerning the node in the receiving-side tree in the storage device comprises a step of storing values indicating insertion positions in an insertion mark array of the same size as that of the first parent-child relationship definition array based on information concerning a position at which the vertex node in the received-side tree is inserted, wherein the values are stored in the insertion mark array for nodes including a node located immediately after the position and its descendant nodes.

Moreover, in another preferred embodiment, the method further comprises the steps of:

generating a first level array in the storage device, the first array containing a level value indicating a depth level of each of the nodes in the receiving-side tree from the vertex node; and

generating a second level array in the storage device by referring to a level value in the first level array corresponding to the insertion position of the vertex node in the received-side tree, the second level array containing a level value indicating the depth level of each of the nodes in the received-side tree from the vertex node in the receiving-side tree;

wherein the step of generating the first and second new node identifier arrays comprises the steps of:

reserving areas for the first and second new node identifier arrays being of the same size as those of the first and second parent-child relationship definition arrays, respectively, in the storage device; and

reserving a current node identifier area in the storage device, the area temporarily storing the new node identifiers, and setting an initial value to the area, and

wherein at positions excluding a position in which a value has been changed to a value indicating that the position is the insertion position in the insertion mark array the method further comprises the steps of:

a. setting a value in the current node identifier area to the first new node identifier array as a value at any of the positions; and

b. then incrementing the value in the current node identifier area, and

wherein at the position where a value is changed to the value indicating that the position is the insertion position in the insertion mark array the method further comprises the steps of:

a. referring to the level value in the first level array at the position, and specifying a range within the second level array including the same level value as that of the first level array;

b. setting the value in the current node identifier area to the second new node identifier array sequentially from a top of the range;

c. then incrementing the value in the current node identifier area;

d. setting the value in the current node identifier area to the first new node identifier array, once values within the range in the second new node identifier array has been set; and

e. then incrementing the value in the current node identifier area.

Moreover, in a more preferred embodiment, the step of generating the parent-child relationship definition array after insertion of the tree comprises the steps of:

reserving an area for the first parent node identifier array of the same size as that of the first parent-child relationship definition array in the storage device;

setting a value in the first new node identifier array to the first parent node identifier array at the same position as that of a value in the first parent-child relationship definition array by referring to the value in the first new node identifier array at a position indicated by a value in the first parent-child relationship definition array;

correlating the values in the first new node identifier array and the values in the first parent node identifier array with each other;

reserving an area for the second parent node identifier array of the same size as that of the second parent-child relationship definition array in the storage device;

setting the node identifier for the parent node of the vertex node in the received-side tree to the top of the second new node identifier array, and setting the value in the second new node identifier array to the second parent node identifier array at the same position as that of a value in the second parent-child relationship definition array by referring to the value in the second new node identifier array at a position indicated by the value in the second parent-child relationship array;

correlating the values in the second new node identifier array and the values in the second parent node identifier array with each other; and

setting the values in the first and second parent node identifier arrays, which are correlated with the values in the first and second new node identifier arrays, respectively, to the parent-child relationship definition array after insertion of the tree.

Moreover, the object of the present invention is achieved by an information processing device configured to delete a subtree including a vertex node, which is a specific node, and descendant nodes of the vertex node, from an original tree and generate a parent-child relationship definition array describing a tree data structure of a resultant tree from which the subtree has been deleted in a storage device, the information processing device having a parent-child relationship definition array describing a tree data structure of the original tree generated and stored in the storage device, in which the parent-child relationship definition array contains node identifiers assigned to parent nodes of respective non-root nodes in association with node identifiers assigned to the non-root nodes, the node identifiers being consecutive integers, which are assigned to nodes including a root node and satisfy a condition such that a node identifier of a parent node is smaller than a node identifier of its child node, and the non-root nodes being nodes other than the root node, characterized in that the information processing device comprising:

a data reading means to read out from the storage device the parent-child relationship definition array for the original tree from which the subtree is to be deleted;

a deletion-flag setting means to set flags for the node identifiers forming the subtree in a deletion-flag array having the same size as the parent-child relationship definition array for the original tree and being generated and stored in the memory device by referring to the node identifier of the vertex node located closest to the root node in the subtree and the parent-child relationship definition array for the original tree;

a new node identifier array generating means to assign new node identifiers to respective nodes in the resultant tree from which the subtree has been deleted such that a parent node and its child node satisfy the condition that a node identifier of the parent node is smaller than that of its child node by referring to the deletion-flag array, and generate a new node identifier array in the storage device, the new node identifier array containing the assigned new node identifiers in association with the node identifiers of the nodes for the original tree; and

a post-deletion parent-child relation array generating means to generate the parent-child relationship array for the resultant tree in the storage device based on the parent-child relationship definition array for the original tree and the new node identifier array, wherein the parent-child relationship array for the resultant tree contains node identifiers of parent nodes of respective nodes having the assigned new node identifiers in association with the assigned new identifiers.

In a preferred embodiment, the node identifiers are consecutive integers which are assigned to the nodes with a higher priority to nodes of same generation over child nodes, and the parent-child relationship array containing the node identifiers assigned to the parent nodes of the respective non-root nodes in association with the node identifiers assigned to the non-root nodes excluding the root node is stored in the storage device, and

the new node identifier array generating means is configured to assign the node identifier to each of the nodes, wherein the node identifier is a consecutive integer assigned to each of the nodes with the higher priority to the nodes of the same generation over the child nodes.

Alternatively, in another preferred embodiment, the node identifier may be consecutive integers which are assigned to the nodes with a higher priority to child nodes over nodes of same generation, and the parent-child relationship array containing the node identifiers assigned to the parent nodes of the respective non-root nodes in association with the node identifiers assigned to the non-root nodes excluding the root node may be stored in the storage device, and

the new node identifier array generating means is configured to assign the node identifier to each of the nodes, wherein the node identifier is a consecutive integer assigned to each of the nodes with the higher priority to the child nodes over the nodes of the same generation.

Also in a preferred embodiment, a node value storage array is stored in the storage device, wherein the node value storage array contains at least a node value for the node of the original tree in association with each of the node identifiers for the nodes of the original tree, and

the device further comprises a node value storage array updating means to update the node value storage array in accordance with a correlation between original node identifiers and the new node identifiers by referring to the new node identifier array.

Also in another more preferred embodiment, a node value storage array is stored in the storage device stores, wherein the node storage array contains at least a node value for the node of the original tree in association with each of the node identifiers for the nodes of the original tree, and

the device further comprises a node value storage array generating means to generate a new node value storage array by referring to the new node identifier array, wherein the new node value storage array containing the node values in association with the respective new node identifiers in accordance with a correlation between original node identifiers and the new node identifiers.

In a more preferred embodiment, the new node identifier array generating means is configured to:

reserve an area for the new node identifier array of the same size as that of the parent-child relationship definition array in the storage device;

reserve a current node identifier area in the storage device, the area temporarily storing the new node identifier, and set an initial value to the current node identifier area; and

set a value stored in the current node identifier area to the new node identifier array if it is determined that a flag in the deletion-flag array is not set by referring to the deletion-flag array and then increment the value in the current node identifier area, or otherwise setting an invalid value to the new node identifier array if it is determined that a flag in the deletion-flag array is set.

In another preferred embodiment, the post-deletion parent-child relationship definition array generating means is configured to:

reserve an area for a storage address array of a same size as that of the parent-child relationship definition array in the storage device;

set the value in the new node identifier array to the storage address array unless it is determined a value located at a storage location in the new node identifier array is the invalid value by referring to the value, the storage location being the same as that of a value in the parent-child relationship definition array;

reserve an area for a parent node identifier array of the same size as that of the parent-child relationship definition array in the storage device;

set a value in the new node identifier array to the parent node identifier array at the same location as that of a value in the parent-child relationship definition array by referring to the value in the new node identifier array at a location indicated by the value in the parent-child relationship definition array; and

generate the parent-child relationship definition array for that resultant tree, the array containing the value from the parent node identifier array in association with the value in the storage address array.

Moreover, the object of the present invention is also achieved by an information processing device configured to add a received-side tree to a receiving-side tree by connecting a root node in the received-type tree to a specific node in the receiving-type tree, and generate a parent-child relationship definition array describing a tree data structure of a resultant tree after the received-type tree has been inserted into the receiving-type tree in a storage device, the information processing device having a parent-child relationship definition array describing a tree data structure of a tree generated and stored in the storage device, in which the parent-child relationship definition array contains node identifiers assigned to parent nodes of respective non-root nodes in association with node identifiers assigned to the non-root nodes, the node identifiers being consecutive integers assigned to nodes including a root node with a higher priority to nodes of same generation over child nodes, and the non-root nodes being nodes other than the root node, characterized in that the information processing device comprising:

a data reading means to read out from the storage device a first parent-child relationship definition array for the receiving-side tree and a second parent-child relationship definition array for the received-side tree;

an insertion position information generating means to specify a node in the receiving-side tree adjacent to each node in the received-type tree based on information concerning a position where a vertex node is to be inserted, the vertex node corresponding to the root node in the received-side tree and being located closest to a root node in a subtree included in the receiving-side tree, and store information concerning the node in the receiving-side tree in the storage device;

a new node identifier array generating means to assign a new node identifier to each of nodes in the receiving-side after insertion of the received-side tree by referring to the information concerning the node in the receiving-side tree, the new node identifier being a consecutive integer assigned to the node with a higher priority to nodes of same generation over child nodes, and generate a first new node identifier array in the storage device, the first new node identifier containing the assigned new node identifier in association with the node identifier for the node in the receiving-side tree before insertion of the received-side tree, and, at the same time, assign a new node identifier to each of nodes in the received-side tree after insertion of the received-side tree based on the information concerning the position where the vertex node in the received-side tree is to be inserted, the node identifier being a consecutive integer assigned to the node with a higher priority to nodes of same generation over child nodes, and generate a second new node identifier array in the storage device, the second new node identifier array containing the assigned new node identifiers in association with the node identifier for the node in the received-side tree before insertion of the received-side tree; and

a post-insertion parent-child relationship definition array generating means to generate the parent-child relationship definition array for the resultant tree after insertion of the received-type tree in the storage device based on the first and second parent-child relationship definition arrays and the first and second new node identifier arrays, the parent-child relationship definition array for the resultant tree containing a node identifier for a parent node of its child node assigned the new node identifier in association with the new node identifiers.

In a preferred embodiment, a first node value storage array and a second node value storage array are stored in the storage device, the first node value storage array containing at least a node value of a node in the receiving-side tree in association with each node identifier for the node in the receiving-side tree and the second node value storage array containing at least a node value of a node in the received-side tree in association with each node identifier for the node in the received-side tree, and

the device further comprises a node value storage array updating means to update at least one of the first and second node value storage arrays in accordance with a correlation between original node identifiers assigned to nodes in the receiving-side tree and the received-side tree and new node identifiers assigned to nodes after insertion by referring to the first and second new node identifier arrays.

In another preferred embodiment, a first node value storage array and a second node value storage array are stored in the storage device, the first node value storage array containing at least a node value of a node in the receiving-side tree in association with each node identifier for the node in the receiving-side tree and the second node value storage array containing at least a node value of a node in the received-side tree in association with each node identifier for the node in the received-side tree, and

the device further comprising a node value storage address generating means to generate a new node value storage array by referring to the first and second new node identifier arrays, wherein the new node value storage array containing the node value in association with each of the new node identifiers in accordance with a correlation between original node identifiers assigned to nodes in the receiving-side tree and the received-side tree and new node identifiers assigned to nodes after insertion.

In a more preferred embodiment, the insertion position information generating means is configured to store values indicating insertion positions in an insertion mark array of the same size as that of the first parent-child relationship definition array based on information concerning a position at which the vertex node in the received-side tree is inserted, wherein the values are stored in the insertion mark array for nodes including a node located immediately after the position and its descendant nodes.

Moreover, in another preferred embodiment, the device further comprises:

a first level array generating means to generate a first level array in the storage device, the first array containing a level value indicating a depth level of each of the nodes in the receiving-side tree from the vertex node; and

a second level array generating means to generate a second level array in the storage device by referring to a level value in the first level array corresponding to the insertion position of the vertex node in the received-side tree, the second level array containing a level value indicating the depth level of each of the nodes in the received-side tree from the vertex node in the receiving-side tree;

wherein the new node identifier array generating means is configured to:

reserve areas for the first and second new node identifier arrays being of the same size as those of the first and second parent-child relationship definition arrays, respectively, in the storage device; and

reserve a current node identifier area in the storage device, the area temporarily storing the new node identifiers, and setting an initial value to the area, and

wherein at positions excluding a position in which a value has been changed to a value indicating that the position is the insertion position in the insertion mark array the device is configured to:

a. set a value in the current node identifier area to the first new node identifier array as a value at any of the positions; and

b. then increment the value in the current node identifier area, and

wherein at the position where a value is changed to the value indicating that the position is the insertion position in the insertion mark array the device is further configured to:

a. refer to the level value in the first level array at the position, and specify a range within the second level array including the same level value as that of the first level array;

b. set the value in the current node identifier area to the second new node identifier array sequentially from a top of the range;

c. then increment the value in the current node identifier area;

d. set the value in the current node identifier area to the first new node identifier array, once values within the range in the second new node identifier array has been set; and

e. then increment the value in the current node identifier area.

Moreover, in a still another preferred embodiment, the post-insertion parent-child relationship definition array generating means is configured to:

reserve an area for the first parent node identifier array of the same size as that of the first parent-child relationship definition array in the storage device;

set a value in the first new node identifier array to the first parent node identifier array at the same position as that of a value in the first parent-child relationship definition array by referring to the value in the first new node identifier array at a position indicated by a value in the first parent-child relationship definition array;

correlate the values in the first new node identifier array and the values in the first parent node identifier array with each other;

reserve an area for the second parent node identifier array of the same size as that of the second parent-child relationship definition array in the storage device;

set the node identifier for the parent node of the vertex node in the received-side tree to the top of the second new node identifier array, and set the value in the second new node identifier array to the second parent node identifier array at the same position as that of a value in the second parent-child relationship definition array by referring to the value in the second new node identifier array at a position indicated by the value in the second parent-child relationship array;

correlate the values in the second new node identifier array and the values in the second parent node identifier array with each other; and

set the values in the first and second parent node identifier arrays, which are correlated with the values in the first and second new node identifier arrays, respectively, to the parent-child relationship definition array after insertion of the tree.

Moreover, the object of the present invention is achieved by a computer-readable information processing program for deleting a subtree including a vertex node, which is a specific node, and descendant nodes of the vertex node, from an original tree and generating a parent-child relationship definition array describing a tree data structure of a resultant tree from which the subtree has been deleted in a storage device in a computer having a parent-child relationship definition array describing a tree data structure of the original tree generated and stored in the storage device, in which the parent-child relationship definition array contains node identifiers assigned to parent nodes of respective non-root nodes in association with node identifiers assigned to the non-root nodes, the node identifiers being consecutive integers, which are assigned to nodes including a root node and satisfy a condition such that a node identifier of a parent node is smaller than a node identifier of its child node, and the non-root nodes being nodes other than the root node, characterized in that the program causes the computer to execute the steps of:

reading out from the storage device the parent-child relationship definition array for the original tree from which the subtree is to be deleted;

setting flags for the node identifiers forming the subtree in a deletion-flag array having the same size as the parent-child relationship definition array for the original tree and being generated and stored in the memory device by referring to the node identifier of the vertex node located closest to the root node in the subtree and the parent-child relationship definition array for the original tree;

assigning new node identifiers to respective nodes in the resultant tree from which the subtree has been deleted such that a parent node and its child node satisfy the condition that a node identifier of the parent node is smaller than that of its child node by referring to the deletion-flag array, and generating a new node identifier array in the storage device, the new node identifier array containing the assigned new node identifiers in association with the node identifiers of the nodes for the original tree; and

generating the parent-child relationship array for the resultant tree in the storage device based on the parent-child relationship definition array for the original tree and the new node identifier array, wherein the parent-child relationship array for the resultant tree contains node identifiers of parent nodes of respective nodes having the assigned new node identifiers in association with the assigned new identifiers.

In a preferred embodiment, the node identifiers are consecutive integers which are assigned to the nodes with a higher priority to nodes of same generation over child nodes, and the parent-child relationship array containing the node identifiers assigned to the parent nodes of the respective non-root nodes in association with the node identifiers assigned to the non-root nodes excluding the root node is stored in the storage device, and

in the step of generating the new node identifier array the program causes the computer to execute a step of assigning the node identifier to each of the nodes, wherein the node identifier is a consecutive integer assigned to each of the nodes with the higher priority to the nodes of the same generation over the child nodes.

In another preferred embodiment, the node identifier may be consecutive integers which are assigned to the nodes with a higher priority to child nodes over nodes of same generation, and the parent-child relationship array containing the node identifiers assigned to the parent nodes of the respective non-root nodes in association with the node identifiers assigned to the non-root nodes excluding the root node may be stored in the storage device, and

in the step of generating the new node identifier array the program causes the computer to execute a step of assigning the node identifier to each of the nodes, wherein the node identifier is a consecutive integer assigned to each of the nodes with the higher priority to the child nodes over the nodes of the same generation.

Also in a preferred embodiment, a node value storage array is stored in the storage device, wherein the node value storage array contains at least a node value for the node of the original tree in association with each of the node identifiers for the nodes of the original tree, and

the program causes the computer to execute a step of updating the node value storage array in accordance with a correlation between original node identifiers and the new node identifiers by referring to the new node identifier array.

In another preferred embodiment, a node value storage array is stored in the storage device stores, wherein the node storage array contains at least a node value for the node of the original tree in association with each of the node identifiers for the nodes of the original tree, and

the program causes the computer to execute a step of generating a new node value storage array by referring to the new node identifier array, wherein the new node value storage array containing the node values in association with the respective new node identifiers in accordance with a correlation between original node identifiers and the new node identifiers.

In a more preferred embodiment, in the step of generating the new node identifier array the program causes the computer to execute the steps of:

reserving an area for the new node identifier array of the same size as that of the parent-child relationship definition array in the storage device;

reserving a current node identifier area in the storage device, the area temporarily storing the new node identifier, and setting an initial value to the current node identifier area; and

setting a value stored in the current node identifier area to the new node identifier array if it is determined that a flag in the deletion-flag array is not set by referring to the deletion-flag array and then incrementing the value in the current node identifier area, or otherwise setting an invalid value to the new node identifier array if it is determined that a flag in the deletion-flag array is set.

In another preferred embodiment, in the step of generating the parent-child relationship definition array after deleting the subtree the program causes the computer to execute the steps of:

reserving an area for a storage address array of a same size as that of the parent-child relationship definition array in the storage device;

setting the value in the new node identifier array to the storage address array unless it is determined a value located at a storage location in the new node identifier array is the invalid value by referring to the value, the storage location being the same as that of a value in the parent-child relationship definition array;

reserving an area for a parent node identifier array of the same size as that of the parent-child relationship definition array in the storage device;

setting a value in the new node identifier array to the parent node identifier array at the same location as that of a value in the parent-child relationship definition array by referring to the value in the new node identifier array at a location indicated by the value in the parent-child relationship definition array; and

generating the parent-child relationship definition array for that resultant tree, the array containing the value from the parent node identifier array in association with the value in the storage address array.

Moreover, the object of the present invention is achieved by a computer-readable information processing program for adding a received-side tree to a receiving-side tree by connecting a root node in the received-type tree to a specific node in the receiving-type tree, and generating a parent-child relationship definition array describing a tree data structure of a resultant tree after the received-type tree has been inserted into the receiving-type tree in a storage device in a computer having a parent-child relationship definition array describing a tree data structure of a tree generated and stored in the storage device, in which the parent-child relationship definition array contains node identifiers assigned to parent nodes of respective non-root nodes in association with node identifiers assigned to the non-root nodes, the node identifiers being consecutive integers assigned to nodes including a root node with a higher priority to nodes of same generation over child nodes, and the non-root nodes being nodes other than the root node, characterized in that the program causes the computer to execute the steps of:

reading out from the storage device a first parent-child relationship definition array for the receiving-side tree and a second parent-child relationship definition array for the received-side tree;

specifying a node in the receiving-side tree adjacent to each node in the received-type tree based on information concerning a position where a vertex node is to be inserted, the vertex node corresponding to the root node in the received-side tree and being located closest to a root node in a subtree included in the receiving-side tree, and storing information concerning the node in the receiving-side tree in the storage device;

assigning a new node identifier to each of nodes in the receiving-side after insertion of the received-side tree by referring to the information concerning the node in the receiving-side tree, the new node identifier being a consecutive integer assigned to the node with a higher priority to nodes of same generation over child nodes, and generating a first new node identifier array in the storage device, the first new node identifier containing the assigned new node identifier in association with the node identifier for the node in the receiving-side tree before insertion of the received-side tree, and, at the same time, assigning a new node identifier to each of nodes in the received-side tree after insertion of the received-side tree based on the information concerning the position where the vertex node in the received-side tree is to be inserted, the node identifier being a consecutive integer assigned to the node with a higher priority to nodes of same generation over child nodes, and generating a second new node identifier array in the storage device, the second new node identifier array containing the assigned new node identifiers in association with the node identifier for the node in the received-side tree before insertion of the received-side tree; and

generating the parent-child relationship definition array for the resultant tree after insertion of the received-type tree in the storage device based on the first and second parent-child relationship definition arrays and the first and second new node identifier arrays, the parent-child relationship definition array for the resultant tree containing a node identifier for a parent node of its child node assigned the new node identifier in association with the new node identifiers.

In a preferred embodiment, a first node value storage array and a second node value storage array are stored in the storage device, the first node value storage array containing at least a node value of a node in the receiving-side tree in association with each node identifier for the node in the receiving-side tree and the second node value storage array containing at least a node value of a node in the received-side tree in association with each node identifier for the node in the received-side tree, and

the program causes the computer to execute a step of updating at least one of the first and second node value storage arrays in accordance with a correlation between original node identifiers assigned to nodes in the receiving-side tree and the received-side tree and new node identifiers assigned to nodes after insertion by referring to the first and second new node identifier arrays.

In another preferred embodiment, a first node value storage array and a second node value storage array are stored in the storage device, the first node value storage array containing at least a node value of a node in the receiving-side tree in association with each node identifier for the node in the receiving-side tree and the second node value storage array containing at least a node value of a node in the received-side tree in association with each node identifier for the node in the received-side tree, and

the program causes the computer to execute a step of generating a new node value storage array by referring to the first and second new node identifier arrays, wherein the new node value storage array containing the node value in association with each of the new node identifiers in accordance with a correlation between original node identifiers assigned to nodes in the receiving-side tree and the received-side tree and new node identifiers assigned to nodes after insertion.

In a more preferred embodiment, in the step of storing information concerning the node in the receiving-side tree in the storage device the program causes the computer to execute a step of storing values indicating insertion positions in an insertion mark array of the same size as that of the first parent-child relationship definition array based on information concerning a position at which the vertex node in the received-side tree is inserted, wherein the values are stored in the insertion mark array for nodes including a node located immediately after the position and its descendant nodes.

Moreover, in another preferred embodiment, the program further causes the computer to execute the steps of:

generating a first level array in the storage device, the first array containing a level value indicating a depth level of each of the nodes in the receiving-side tree from the vertex node; and

generating a second level array in the storage device by referring to a level value in the first level array corresponding to the insertion position of the vertex node in the received-side tree, the second level array containing a level value indicating the depth level of each of the nodes in the received-side tree from the vertex node in the receiving-side tree;

wherein in the step of generating the first and second new node identifier arrays the program causes the computer to execute the steps of:

reserving areas for the first and second new node identifier arrays being of the same size as those of the first and second parent-child relationship definition arrays, respectively, in the storage device; and

reserving a current node identifier area in the storage device, the area temporarily storing the new node identifiers, and setting an initial value to the area, and

wherein at positions excluding a position in which a value has been changed to a value indicating that the position is the insertion position in the insertion mark array the program causes the computer to execute the steps of:

a. setting a value in the current node identifier area to the first new node identifier array as a value at any of the positions; and

b. then incrementing the value in the current node identifier area, and

wherein at the position where a value is changed to the value indicating that the position is the insertion position in the insertion mark array the program further causes the computer to execute the steps of:

a. referring to the level value in the first level array at the position, and specifying a range within the second level array including the same level value as that of the first level array;

b. setting the value in the current node identifier area to the second new node identifier array sequentially from a top of the range;

c. then incrementing the value in the current node identifier area;

d. setting the value in the current node identifier area to the first new node identifier array, once values within the range in the second new node identifier array has been set; and

e. then incrementing the value in the current node identifier area.

Moreover, in another preferred embodiment, in the step of generating the parent-child relationship definition array after insertion of the tree the program causes the computer to execute the steps of:

reserving an area for the first parent node identifier array of the same size as that of the first parent-child relationship definition array in the storage device;

setting a value in the first new node identifier array to the first parent node identifier array at the same position as that of a value in the first parent-child relationship definition array by referring to the value in the first new node identifier array at a position indicated by a value in the first parent-child relationship definition array;

correlating the values in the first new node identifier array and the values in the first parent node identifier array with each other;

reserving an area for the second parent node identifier array of the same size as that of the second parent-child relationship definition array in the storage device;

setting the node identifier for the parent node of the vertex node in the received-side tree to the top of the second new node identifier array, and setting the value in the second new node identifier array to the second parent node identifier array at the same position as that of a value in the second parent-child relationship definition array by referring to the value in the second new node identifier array at a position indicated by the value in the second parent-child relationship array;

correlating the values in the second new node identifier array and the values in the second parent node identifier array with each other; and

setting the values in the first and second parent node identifier arrays, which are correlated with the values in the first and second new node identifier arrays, respectively, to the parent-child relationship definition array after insertion of the tree.

### ADVANTAGE OF THE INVENTION

According to the invention, it is enabled to provide a method of deleting, from a tree with efficiency, a subtree being a part of the tree, or a method of tree insertion of a tree, an information processing device, and a program.

### BEST MODE FOR CARRYING OUT THE INVENTION

In the below, by referring to the accompanying drawings, an embodiment of the present invention is described.

[Configuration of Computer System]

FIG. 1 is a block diagram showing the hardware configuration of an information processing device that handles a tree data structure in an embodiment of the present invention. As shown in FIG. 1, this information processing device 10 is of the configuration similar to an ordinary computer, and is configured to include a CPU 12 that controls the device in its entirety and the individual components by executing a program, a RAM (Random Access Memory) 14 that stores work data and others, a ROM (Read Only Memory) 16 that stores programs and others, a hard disk device 18, a driver 20 for access of a CD-ROM 19, an interface (I/F) 22 via which the drive 20 or external terminals connected to an external network (not shown) is provided, an input unit 24 including a keyboard and a mouse, and a display unit 26. Over a bus 28, mutual connections are established among the CPU 12, the RAM 14, the ROM 16, the hard disk device 18, the I/F 22, the input unit 24, and the display unit 26. In the above embodiment, the computer system 10 is configured to read data stored in the CD-ROM 19 by the driver 20. This is surely not restrictive, and alternatively, the system may be configured to be able to read data stored in a CD-R/W, a DVD-ROM, a DVD-RAM, and others.

A program of the embodiment of constructing a tree data structure on a memory such as the RAM 14, or a program of converting the tree data structure on the memory may be housed in the CD-ROM 19 for reading by the driver 20, or may be stored in advance in the ROM 16. Alternatively, a program read from the CD-ROM 19 for a time may be stored in any predetermined area of the hard disk device 18. Still alternatively, the above program may be supplied from the outside over a network (not shown), any external terminal, and the I/F 22.

Moreover, the information processing device in the embodiment of the present invention is implemented by causing a computer to execute the program of constructing a tree data structure on a memory, and the program of converting the tree data structure on the memory. This program of converting a tree data structure on a memory includes a program of implementing a tree insertion process, and a program of implementing a tree deletion process that will be described later.

[Tree Data Structure]

FIGS. 2A and 2B are each a diagram illustrating POS data being an example of tree-form data. FIG. 2A shows an exemplary visual representation of the data structure (i.e., topology) and data values of this tree-form data, and FIG. 2B shows an exemplary representation of the same tree-form data in the XML format. As shown in FIGS. 2A and B, the structure of the tree-form data is represented by the combination of node and arc starting from a root node (POS data in this example) and reaching a leaf node (end point) after being branched at each node. Each node is correlated with item name information, i.e., node type and item value information, i.e., a node value. In FIG. 2B example, a node corresponding to

<shopName> France shop </shopName>
in the XML format is correlated with the node type of “shopName (=shop name)” and a node value of “France Shop”. This correlation can be implemented by providing, to a node identifier, a pointer to a node information storage area where information specifying a node type and a node value is stored. However, it is required to note that the present invention is not restricted in terms of the manner of handling any substantial values of the tree data structure.

In comparison therewith, for effective search, compilation, and sorting of data of the tree data structure, a technique for representing the topology of the tree data structure, i.e., a technique for expanding the tree data structure on a storage device, plays a very important role. As such, in the below, described mainly is the topology of the tree data structure.

Previously, such a tree data structure has been represented through pointer-connection among nodes each storing data. However, such pointer representation has a drawback that the pointer value has no inevitability. That is, in some cases, a specific node A is stored at a specific location (e.g., address of 100), and in other cases, the same node A is stored at another location (e.g., address of 200). As such, the pointer value is not constant, and the pointer value is merely inherently representing the storage addresses of nodes. Therefore, when the nodes are pointer-connected together in accordance with the rule of depth-first, for example, it is difficult to pointer-connect these nodes again in accordance with the rule of width-first this time.

In comparison therewith, the inventor pays attention that the topology of the tree data structure can be described by an arc list. The arc list is a list of arcs representing the parent-child relationship among nodes. FIGS. 3A to 3C are each a diagram illustrating an exemplary representation format of a tree data structure using an arc list. The examples of the drawings show the tree data structure configured by 12 nodes provided with, respectively, node identifiers (ID) of “0”, “10”, “20”, “30”, “40”, “50”, “60”, “70”, “80”, “90”, “100”, and “110”. FIG. 3A shows the tree data structure in its entirety. In FIG. 3A, numbers indicated at the center of circular or heart-shaped graphics (each showing the node type) each represent a node ID, and an arrow and a pair of numbers such as <0, 10> found on the arrow side represents an arc. Note here that the node ID is not restrictive to a character string, and may be a numerical value, especially an integer. FIG. 3B shows an arc list from a parent node (From-ID) to a child node (To-ID), and FIG. 3C shows a node list being a list of pairs of node ID and node Type. Note that such a node list is not necessarily provided if the purpose is only for representing the tree data structure. In principle, using such an arc list enables to directly describe the relationship among the nodes without depending on a pointer.

[Representation Based on “Child→Parent” Relationship]

In examples of FIGS. 3A to 3C, the arc list is described based on the “parent→child” relationship, which associates a child node with a parent node. Accordingly, for a single parent node, e.g., a root node 0, there are three child nodes of 10, 60, and 80, and thus “From-ID” in the arc list includes three “0” being the same node ID. That is, even if a parent node is specified, a child node cannot be specified, and thus the arc list is configured by the array of elements From-ID and the array of element To-ID. When the arc list is used, a specific node appears both in the array of From-ID and the array of To-ID.

On the other hand, the parent-child relationship can be represented also by the “child→parent” relationship. If this is the case, the “parent-child” relationship among the nodes is represented by the array of the combination of a non-root node not being the root node and a parent node correlated to the non-root node. When the “child→parent” relationship is used to represent the parent-child relationship, there are significant characteristics that could not be derived with the “parent→child” relationship. That is, every child node never fails to have its only own parent node, and specifying a child node enables to directly specify a parent node corresponding uniquely to the child node. It means that the arc list is actually sufficient to include in advance the array of elements To-ID. As a result, the storage capacity can be reduced for storage of the arc list. Reducing the storage capacity as such can lead to the effects of being able to reduce the access frequency to a memory so that, as a result, the processing can be performed with a higher speed.

FIGS. 4A to 4C are each a diagram illustrating a method of representing a tree data structure based on the “child→parent” relationship of the embodiment of the present invention. FIG. 4A is a diagram illustrating a tree in its entirety, and FIG. 4B is an arc list based on the “child→parent” relationship. The arc list of FIG. 4B is including a storage area for a parent node with respect to the root node, and as a parent node of the root node, a setting of “-” is made for the sake of convenience. However, because there is no parent node for the root node, as shown in FIG. 4C, the storage area for a parent node with respect to the root node may be eliminated from the arc list based on the “child→parent” relationship. As such, in the embodiment of the present invention, a parent node of the non-root node is correlated to the respective non-root nodes not being the root node so that the parent-child relationship among the nodes is represented. Thereafter, by tracing the list of the parent node from the child node under the representation of “child→parent”, the topology of the tree can be represented.

According to the embodiment of the present invention, as shown in FIG. 5, the tree data structure based on such a “child→parent” relationship is constructed on the RAM 14 by causing the computer system 10 shown in FIG. 1 to execute a node defining step 501 of providing a unique node identifier to the nodes including the root node, and a parent-child relationship defining step 502 of establishing a correlation between a node identifier provided to each of the non-root nodes not being the root node and a node identifier assigned to a parent node of each of the non-root nodes. As such, first of all, by assigning a node identifier to a node by any arbitrary identification information such as character string, floating point, and integer, and then by defining the parent-child relationship based on the “child→parent” representation, the topology of the tree can be represented by extracting (by looking up) the node identifier of the parent node from the node identifier of the child node.

[Node Identifier]

According to a preferable embodiment, in the node defining step, a node identifier is a numerical value, and more preferably, a sequence of integers, and still more preferably, a sequence of integers starting from “0” or “1”. This enables to easily acquire, from the node identifier, the address at which the node identifier of a parent node corresponding to the node, thereby being able to increase the speed for the processing of extracting the node identifier of a parent node from the node identifier of a child node.

When the parent-child relationship among the nodes is represented by assigning, as a node identifier, a sequence of numbers to the nodes of tree data structure, there are advantages of being able to ease the future handling of the tree data structure thereafter by defining a rule of the order of such number assignment. According to the present invention, as the rule of the order of number assignment, used are a depth-first mode with which a child node has a higher priority over a node of the same generation, and a width-first mode with which a node of the same generation has a higher priority over a child node.

FIGS. 6A to 6C are each a diagram illustrating a process of converting tree configuration data of ID format into tree configuration data of serial integer number format according to the embodiment of the present invention. FIG. 6A shows the tree configuration data in which each node is provided with an ID number, FIG. 6B shows a conversion rule, and FIG. 6C shows the tree structure data in which nodes are provided with a sequence of integers. The conversion rule of this example is a rule of providing a sequence of numbers with a priority over the depth. To be specific, when there are a plurality of child nodes, an eldest (eldest sibling) node is assigned the smallest number, a youngest (youngest sibling) node is assigned a larger number, and such number assignment is performed with a higher priority given to child nodes over sibling nodes. In this example, the number assignment is performed in the ascending order, but alternatively, the descending order will also do.

FIGS. 7A to 7C are each another diagram illustrating the process of converting tree configuration data of ID format into tree configuration data of serial integer number format according to the embodiment of the present invention. FIG. 7A shows the tree configuration data in which each node is provided with an ID number, FIG. 7B shows a conversion rule, and FIG. 7C shows the tree structure data in which nodes are provided with a sequence of integers. The conversion rule of this example is a rule of providing a sequence of numbers with a priority over the width. To be specific, when there are a plurality of child nodes, an eldest (eldest sibling) node is assigned the smallest number, a youngest (youngest sibling) node is assigned a large number, and such number assignment is performed with a higher priority given to sibling nodes over child nodes. In this example, the number assignment is performed in the ascending order, but alternatively, the descending order will also do.

Using numbers for node identifiers as such enables to extract, from a node number, any address at which a storage value is stored for the node at once, i.e., in the order of 0(1). Moreover, by representing the parent-child relationship by “child→parent”, this enables to extract a parent node from a child node at once, i.e., in the order of 0(1).

[Depth-First Mode]

According to the embodiment of the present invention, the tree data structure based on the depth-first as shown in FIG. 6C is constructed on a storage device by causing the computer system 10 of FIG. 1 to execute

a node defining step of assigning a sequence of integers unique to nodes including a root node with a higher priority to child nodes over nodes of the same generation, and

a parent-child relationship defining step of storing, in the storage device, an array as a result of arranging, in order of the integers assigned to each non-root node not being the root node, the integers assigned to a parent node of each of the non-root nodes. As such, the nodes are assigned a sequence of integers with the depth-first, and the parent-child relationship among the nodes is represented by the array of “child→parent” relationship.

FIG. 8 is a flowchart of a node defining process based on the depth-first in the embodiment of the present invention. In this node defining process, the computer system 10 is made to execute

a step 801 of firstly assigning a number to a root node,

a step 802 of assigning, when a specific node already assigned a number includes its only own child node, the child node a number next to the number assigned to the specific node, and

a step 803 of performing, when the specific node already assigned a number includes a plurality of child nodes, in accordance with the sibling relationship among a plurality child nodes, number assignment from the eldest sibling node to the youngest sibling node in such a manner that any of the younger sibling nodes is assigned a one-larger number after every descendant node of the immediately elder sibling is through with number assignment. In this manner, the sibling relationship is defined with the depth-first mode among a plurality of child nodes rooted from the same parent node.

FIG. 9 is a diagram illustrating an array created from the tree data structure of FIG. 6C with a depth-first for a parent-child relationship based on the “child→parent” representation according the embodiment of the present invention. As shown in FIG. 9 as a subtree 1 or a subtree 2, when the parent-child relationship among nodes assigned with a sequence of numbers with a depth-first is represented in an array based on the “child→parent” relationship, derived are the outstanding characteristics that descendent nodes of a specific node appear in consecutive locations.

In the embodiment of the present invention, by utilizing such outstanding characteristics of the depth-first mode, extracting any consecutive locations storing a value larger than the integer assigned to a specific node from the array enables to specify every descendent node for the specific node. As a result, a group of nodes representing the descendent nodes of the specific node can be acquired as consecutive blocks in the array. Assuming that the size of the consecutive blocks is “m”, the processing speed for specifying every descendent node of a specific node will be of the order of O(m).

As already described above, the parent-child relationship among the nodes can be represented not only by the array of “child→parent” relationship but also by the array of “parent→child” relationship. FIG. 10 is a diagram illustrating an array created by the embodiment of the present invention from the tree data structure of FIG. 6C with a depth-first for a parent-child relationship based on the “parent→child” representation. Herein, because a single parent node may include a plurality of child nodes, the array of the parent-child relationship is configured by two arrays of an array Aggr for indicating any area storing numbers assigned to child nodes of each of the nodes, and an array P→C storing the numbers assigned to the child nodes. For example, the value of an element Aggr[1] located at the second from the head of the array Aggr is “3”, and this indicates that the number of a child node for a node [1] is stored after an element P→C[3] in the array P→C. This tells that child nodes for a node [0], i.e., a root node, are three elements in the array of P→C from the head, including “1” of P→C[0], “6” of P→C[1], and “8” of P→C[2].

Described now is how to find the array of the parent-child relationship based on this “parent→child” representation.

1. When the number of a node is the same as the largest subscript (=11) in the array P→C, there is no child node for this node. Therefore, the processing is not continued.

2. Find an Aggr value from the number of a parent node bolded in the drawing. This Aggr value indicates the starting point of the array P→C.

3. Find an Aggr value corresponding to the value larger by 1 than the number of the bolded parent node. The value smaller by 1 than this Aggr value is the end point of the array P→C.

For example, the starting point for a child node of the node 0 is Aggr[0], i.e., “0”, and the end point therefor is Aggr[1]-1, i.e., “3−1=2”. As such, the child node of the node 0 is the elements located from the 0th to the 2nd of the array P→C, i.e., “1”, “6”, and “8”.

Alternatively, the parent-child relationship based on the “parent→child” representation can be represented more simply by two arrays including an array of numbers of parent nodes, and an array of numbers of child nodes corresponding thereto. However, to find the parent-child relationship using such arrays, there requires to make a search for the numbers of the parent nodes, i.e., requires the access time of log(n), and this is not efficient.

[Width-First Mode]

According to the embodiment of the present invention, the tree data structure based on a width-first as shown in FIG. 7C is constructed on a storage device by causing the computer system 10 of FIG. 1 to execute

a node defining step of assigning a sequence of integers unique to nodes including a root node with a higher priority to nodes of the same generation over child nodes, and

a parent-child relationship defining step of storing, in the storage device, an array as a result of arranging, in order of the integers assigned to each non-root node not being the root node, the integers assigned to a parent node of each of the non-root nodes. As such, the nodes are assigned a sequence of integers with the width-first mode, and the parent-child relationship among the nodes is represented by the array of “child→parent” relationship.

FIG. 11 is a flowchart of a node defining process based on the width-first in the embodiment of the present invention. In this node defining process, the computer system 10 is made to execute

a step 1101 of calculating, in terms of generation, the position of each of the nodes from the root node, and the number of nodes for each of the generations,

a step 1102 of firstly assigning a number to the root node,

a step 1013 of performing, after completing number assignment for every node in a specific generation, until no node is found in a generation next to the specific generation, when nodes in the next generation do not have the same parent node, assigning numbers to the nodes in order of the number assignment performed to the parent nodes, and when the nodes have the same parent node, defining a sibling relationship among a plurality of child nodes rooted from the parent node, and performing assignment, in order, of a unique sequence of integers showing a continuous change from a number next to the number assigned to immediately preceding node from the eldest sibling node to the youngest sibling node. As such, the sibling relationship is defined with the width-first mode among a plurality of child nodes rooted from the same parent node.

FIG. 12 is a diagram illustrating an array created by the embodiment of the present invention from the tree data structure of FIG. 7C with a width-first for a parent-child relationship based on the “child→parent” representation. As shown in FIG. 12, when the parent-child relationship among nodes assigned a sequence of numbers with the width-first is represented in array based on the “child→parent” relationship, derived are the outstanding characteristics that child nodes of a specific node appear in areas in a row. This is because when the parent-child relationship among nodes assigned a sequence of numbers with the width-first mode is represented in array based on the “child→parent” relationship, the numbers assigned to parent nodes appear in the array in order (ascending order or descending order).

As such, in the embodiment of the present invention, by utilizing such outstanding characteristics of the width-first mode, extracting any consecutive locations storing a value same as the integer assigned to a specific node from the array enables to specify every child node for the specific node. As a result, a search can be made for child nodes of the specific node utilizing a technique such as binary search or others, i.e., a search can be made therefor in the order of O(log(n)

As already described above, the parent-child relationship among nodes can be represented not only by the array of “child→parent” relationship but also by the array of “parent→child” relationship. FIG. 13 is a diagram illustrating an array created from the tree data structure of FIG. 7C with the width-first for a parent-child relationship based on the “parent→child” representation. Herein, as shown in FIG. 13, because a single parent node may include a plurality of child nodes, the array of the parent-child relationship is configured by two arrays of an array Aggr for indicating any area storing numbers assigned to child nodes of each of the nodes, and an array P→C storing the numbers assigned to the child nodes. For example, the value of an element Aggr[1] located at the second from the head of the array Aggr is “3”, and this indicates that the number of a child node for a node [1] is stored after an element P→C[3] in the array P→C. This tells that a child node for a node [0], i.e., a root node, is three elements in the array of P→C from the head, including “1” of P→C[0], “2” of P→C[1], and “3” of P→C[2]

Described now is how to find the array of the parent-child relationship based on this “parent→child” representation.

1. When the number of a node is the same as the largest subscript (=11) in the array P→C, there is no child node for this node. Therefore, the processing is not continued.

2. Find an Aggr value from the number of a parent node bolded in the drawing. This Aggr value indicates the starting point of the array P→C.

3. Find an Aggr value corresponding to the value larger by 1 than the number of the bolded parent node. The value smaller by 1 than this Aggr value is the end point of the array P→C.

For example, the starting point for a child node of the node 0 is Aggr[0], i.e., “0”, and the end point therefor is Aggr[1]-1, i.e., “3−1=2”. As such, the child node of the node 0 is the elements located from the 0th to the 2nd of the array P→C, i.e., “1”, “2”, and “3”.

[Mutual Conversion of Representation Format of Tree Data Structure]

As described above, the depth-first mode and the width-first mode for assigning nodes a sequence of numbers each have unique outstanding characteristics. Although no detail description will be given, as shown in FIG. 14, the information processing device 10 of the embodiment of the present invention can convert the representation format among the representation format of “child→parent” based on a depth-first, the representation format of “child→parent” based on a width-first, and the “parent→child” representation format.

### [Deletion of Tree]

Described next is deletion of tree being one operation of editing the topology of the tree data structure. The “deletion of tree” of the present invention means, in the tree data structure, deleting, from a whole tree, any specific node and a descendent node(s) of the node (i.e., subtree(s)). In actuality, from a parent-child relationship definition array stored in a memory for representing the tree data structure under the representation of “child→parent” (hereinafter, referred to as “C→P array”, and in the drawing, represented as “C->P” or “C-P”), information about any node corresponding to the subtree is deleted, and for the remaining node(s), a C-P array storing new node identifiers assigned exemplarily in accordance with the width-first mode is generated in a memory. Note that the subtree to be deleted from the whole tree may include a subtree formed by a single node. Moreover, in this specification, in the tree data structure, a node group including a specific node and other nodes branching from the specific node and reaching leaf nodes is referred to as subtree. Further, in the subtree, any node closest to a root node is referred to as vertex node.

In the below, in the embodiment of the present invention, described is deletion of tree when a tree data structure is represented with the width-first mode, and in accordance with the width-first mode, a C-P array storing therein node identifiers of nodes configuring the tree is stored in a memory.

FIG. 15 is a diagram visually showing an exemplary tree data structure represented with the width-first mode of the embodiment. In this tree data structure, exemplified now is the case of deleting a subtree whose vertex node is a node under a node identifier “2” (refer to a reference numeral 1501). In the process of deletion of tree, basically, while the subtree whose vertex node is under the node identifier “2” is being eliminated from a whole tree, in accordance with the width-first mode, the remaining nodes are newly each assigned a node identifier, and the array of the node identifiers is stored in a memory or the like.

FIG. 16 is a flowchart showing the process of deletion of tree in this embodiment. As shown in FIG. 16, the CPU 12 keeps, in a memory such as the RAM 14, a delete flag array, a new node identifier array, and a current node number area (step 1601). Thereafter, for a node identifier of a vertex node of a subtree being a deletion target, the CPU 12 performs a flag setting to the delete flag array (step 1602). Note here that, as to a deletion target, an operator may set a vertex node by operating the input unit 24 with reference to the topology of such a tree data structure as shown in FIG. 15 (node 1501 in this example) displayed on the display unit 26.

FIG. 17 is a diagram showing an array of the parent-child relationship in such a tree data structure as shown in FIG. 15, a delete flag array storing an initial value (in the drawing, denoted as “Delete Flag”), a new node identifier array (in the drawing, denoted as “New Node No.”), and a current node identifier area containing the initial value (in the drawing, denoted as “Current Node No.”).

In this example, the subtree whose vertex node is the node under the node identifier “2” is deleted. Thus, as shown in FIG. 17, in a delete flag array 1701, the element about the node identifier “2” is set to “1” (i.e., a flag setting is made). Moreover, a current node identifier area 1702 is stored with an initial value “0”.

The CPU 12 initializes a processing target position to “0” for specifying a node for use as a processing target (step 1603). In the delete flag array, the CPU 12 checks the flag at the processing target position (step 1604), and determines whether a flag setting is made or not (step 1605). If “No” in step 1605, the CPU 12 then checks the flag of the parent node of the node at the processing target position in the delete flag array (step 1606), and determines whether a flag setting is made (step 1607). If “No” in step 1607, the CPU 12 stores the value of the current node identifier area at the processing target position in the new node identifier array, and increments the value of the current node identifier area (step 1608).

On the other hand, if “Yes” in step 1605 or “Yes” in step 1607, the CPU 12 sets “1” to an element at the processing target position in the delete flag array, and in the new node identifier array, stores “−1” at the processing target position (step 1609).

When a node under a specific node identifier is belonging to the subtree being a deletion target, a determination is made as “Yes” in step 1605 or in step 1607. If this is the case, an element corresponding in the delete flag array is set with “1” to make the node evident as being a delete target. Moreover, in the new node identifier array, to make the node as being a delete target, a specific value “−1” is provided.

On the other hand, when a node under a specific node identifier is not belonging to the subtree being a deletion target, a new node identifier, except for a node identifier assigned to one or more nodes configuring the subtree being the deletion target, is assigned to the node. In the new node identifier array, the new node identifier is stored.

By referring to FIGS. 18A and 18B, FIGS. 19A and 19B, and FIG. 20, a process of deleting a subtree including a vertex node under a node identifier “2” will be described in connection with the example of FIG. 15.

As shown in FIG. 18A, with a processing target position of “0”, a determination is made as “No” in step 1605 and step 1607. As a result, the value “0” of the current node identifier area is stored at the processing target position “0” in the new node identifier array, and thereafter, the value of the current node identifier area is incremented so that the resulting value is “1”. As shown in FIG. 18B, with a processing target position of “1”, a determination is also made as “No” in step 1605 and step 1607. As a result, the value “1” of the current node identifier area is stored at the processing target position “1” in the new node identifier array, and thereafter, the value of the current node identifier area is incremented so that the resulting value is “2”.

As shown in FIG. 19A, with a processing target position of “2”, a determination is made as “Yes” in step 1605. As a result, the value of the processing target position “2” is set (although setting is already made in actuality) to “1” in the delete flag array, and in the new node identifier array, “−1” is stored as a value of the processing target position “2”. As shown in FIG. 19B, with a processing target position “6”, a determination is made as “Yes” in step 1607. As a result, in the delete flag array, the value of the processing target position “6” is set to “1”, and in the new node identifier array, “−1” is stored as the value of the processing target position “6”.

When the process of FIG. 16 is executed to every node (i.e., nodes under the node identifiers “0” to “11”) (refer to steps 1610 and 1611 of FIG. 16), the resulting array will be obtained as shown in FIG. 20. Based on the new node identifier array, the CPU 12 generates a C-P array of a tree through with deletion of nodes configuring the subtree.

FIG. 21 is a flowchart showing a process for generating a C-P array after deletion of tree (tree deletion process 2). As shown in FIG. 21, the CPU 12 reserves an area for a new C-P array in a memory (step 2101). Note here that the size of the area for the new C-P array may be smaller than the size of the C-P array before the deletion of tree, and thus it will be sufficient to reserve the area having the same size as that of the C-P array before the deletion of tree. Next, the CPU 12 reserves, in the memory, an area for a storage address array for temporarily storing the storage addresses in the new C-P array (i.e., numbers of storage positions), and an area for a parent node identifier array for temporarily storing the node identifier of the parent node of each of the nodes after the deletion of tree (step 2102). The size of these arrays may be the same as the size of the C-P array.

The CPU 12 initializes the processing target position to “0” (step 2103). The CPU 12 performs calculation of storage address and calculation of node identifier of a parent node for each of the nodes being the processing targets. For calculation of storage address, the CPU 12 acquires the value of the processing target position in the new node identifier array (step 2104). Then, the CPU 12 stores the value acquired in step 2104 to the processing target position in the storage address array (step 2105). Note here that when the value in the new node identifier array is “−1”, a null value is stored in the storage address array.

FIGS. 22A to 22D are each a diagram illustrating, specifically, the processes to be executed in step 2104 and step 2105. As shown in FIG. 22A, for example, with the processing target position of “0”, the value “0” of the storage position number “0” is acquired from the new node identifier array, and thus acquired value “0” is stored at the position of the storage position number “0” in the storage address array (in the drawing, indicated as “Addr”). Also, as shown in FIG. 22B, with the processing target position of “1”, the value “1” of the storage position number “1” is acquired from the new node identifier array, and thus acquired value “1” is stored at the position of the storage position number “1” in the storage address array.

On the other hand, as shown in FIG. 22C, with the processing target position of “2”, the value “2” of the storage position number is acquired from the new node identifier array, but this value is “−1”. As such, in the storage address array, a null value is stored at the position of the storage position number “2”. Such a process is repeated, and as shown in FIG. 22D, the resulting storage address array carries therein values.

For calculation of a node identifier of a parent node, the CPU 12 acquires a value (node identifier) of a processing target position in the C-P array (step 2106), and acquires a value of the position indicated by the value (node identifier) of the C-P array in the new node identifier array (step 2107). The CPU 12 also stores the acquired value of the new node identifier array at the processing target position in the parent node identifier array (step 2108). Although not shown in FIG. 21, when the value (node identifier) of the C-P array is “−1”, the value “−1” is exceptionally stored at the same processing target position in the parent node identifier array. This is the exceptional process with respect to a root node.

FIGS. 23A to 23D are each a diagram illustrating specifically the processes to be executed by steps 2106 to 2108. As shown in FIG. 23A, for example, with the processing target position of “0”, the value of the C-P array is “−1”, and thus as the exceptional process, “−1” is stored in the parent node identifier array (in the drawing, denoted as “P-Node”) as the value of the storage position number “0”. As shown in FIG. 23B, with the processing target position of “1”, the value of the C-P array is “0”, and thus the value “0” of the storage position number “0” is acquired in the new node identifier array. This acquired value “0” is stored at the processing target position “1” (position at the storage position number “1”) in the parent node identifier array. Similarly, as shown in FIG. 23C, with the processing target position of “2”, the value of the C-P array is “0”, and thus the value “0” of the storage position number “0” is acquired in the new node identifier array. This acquired value “0” is stored at the processing target position “2” (position at the storage position number “2”) in the parent node identifier array. Note that the value of the parent node identifier array at the processing target position “2” takes a null value for the storage address as will be described later, and thus is not used after all. Such a process is repeated, and as shown in FIG. 23D, the resulting parent node identifier array contains values.

For every node identifier, calculation of storage address (steps 2104 and 2105), and calculation of node identifier of a parent node (steps 2106 to 2108) are performed (refer to steps 2109 and 2110). Thereafter, the CPU 12 sets the value (node identifier) in the parent node identifier array at a position indicated by at a specific storage position number to the new C-P array at a position indicated by a value in the storage address array, wherein the value in the storage address array is located at the position indicated by the specific storage position number (step 2111). Also for the process of step 2111, in actuality, the processing target position is initialized, and for each of the processing target positions, a storage address and a parent node identifier are acquired, and the parent node identifier may be stored into the new C-P array. Note here that when the value of the storage address array is a null value, the value storage to the new C-P array is skipped.

FIGS. 24A and 24B each show an exemplary storage address array as a result of the processing of FIGS. 22A to 22D, and an exemplary parent node identifier array as a result of the processing of FIGS. 23A to 22D. For example, the value of the storage position number “0” in the storage address array is “0”, and thus, the value “−1” at a position of “0” in the parent node identifier array is set to the new C-P array at the position indicated by the value “0” of the storage address array, wherein the positions of “0” in the new C-P array and the parent node identifier array are identical. Similarly, in the storage address array, the value of the storage position number “1” is “1”, and thus, in the new C-P array, at the position indicated by the value “1” of the storage address array, the value “0” at the position of “1” being the same storage position number in the parent node array is stored. With the storage position number “2”, the value in the storage address array takes a null value, and thus value storage to the new C-P array is skipped. By repeating such a process, the resulting new C-P array looks like the one shown in FIG. 24C.

As described above, the process in step 2111 corresponds to deriving any new C-P array by combining the storage address array and the parent node identifier array without the null value in the storage address array.

FIG. 25A is a diagram visually showing an exemplary tree data structure same as that of FIG. 15, and showing that a subtree whose vertex node is the node under the node identifier “2” is deleted from this tree. If the tree data structure is visually shown based on the C-P array of FIG. 24C, the result looks like the one shown in FIG. 25B. By referring to FIG. 25B, the node under the node identifier “2” and the node under the node identifier “6” being the descendant node thereof are both being deleted, and it shows that the deletion of tree of this embodiment is completed.

[Insertion of Tree]

Described next is insertion of tree being one operation of editing the topology of the tree data structure. The “insertion of tree” of the present invention means adding, to a specific node in a tree, any other tree in which one node is a root node (i.e., as a root node being a vertex node, add a vertex node and its descendent nodes to the specific node).

Herein, the tree which is added to the specific node is referred to as received-side tree, and the tree having the specific node, to which the other tree is added, is referred to as receiving-side tree. In actuality, a C-P array containing a node identifier assigned to each node in accordance with the width-first mode is generated in the memory from one C-P array stored in the memory and describing a received-side tree and other C-P array stored in the memory and describing a receiving-side tree, wherein the received-side tree has been inserted into the receiving-side tree. Alternatively, the receiving-side tree and/or received-side tree may be each formed by a single node.

In the below, in the embodiment, described is the insertion of tree when a tree data structure is represented with the width-first mode, and when a C-P array storing the node identifier of a node configuring the tree in accordance with the width-first mode is stored in a memory.

FIG. 26A is a diagram visually showing an exemplary tree data structure represented with the width-first mode of the embodiment. In FIG. 26A, exemplified is a case where a tree data structure 2600 is a receiving-side tree, and a tree whose vertex node is a node under the node identifier “0” (a root node: refer to a reference numeral 2601) is inserted, as a received-side tree (refer to a reference numeral 2610), between the node of the receiving-side tree under the node identifier “1” and the node thereof under the node identifier “2”. That is, the node of the received-side tree under the node identifier “0” is linked as a child node of the node of the receiving-side tree under the node identifier “0”. In this example, the node of the receiving-side tree under the node identifier “0” is already linked with the node of the receiving-side tree under the node identifier “1” and the node thereof under the node identifier “2” each as a child node. The node of the received-side tree under the node identifier “0” is located lower than the node of the receiving-side tree under the node identifier “1”, and is linked as a child node located upper than the node under the node identifier “2” as a child node of the node of the receiving-side tree under the node identifier “0”

FIG. 26B is the one in which the tree 2600 and the tree 2610 are each represented by a C-P array. As shown in FIG. 26B, in the state before insertion, in each of the trees, their nodes are each assigned a number (node identifier) in accordance with the width-first mode, and the information is stored as an array in a memory. For example, an operator can specify the position for inserting a tree (refer to a reference numeral 2602) by referring to, through operation of the input unit 24, such a tree data structure as shown in FIG. 26A displayed on the screen of the display unit 26. With such an operator's specifying, in the C-P array related to the tree 2600, it is possible to find the position for insertion of the C-P array related to the tree 2610 (refer to a reference numeral 2621).

FIG. 27 is a flowchart showing the outline of the insertion of tree of this embodiment. Note that, through operation of the input unit 24 by an operator, the C-P array of the receiving-side tree, the C-P array of the received-side tree, and the position for insertion of the vertex node of the received-side tree are provided in advance. The position for insertion of the vertex node of the received-side tree can be specified by information about to which node it belongs (node identifier of the receiving-side tree serving as a parent node of the vertex node of the received-side tree), and information indicating the rank of the vertex node of the received-side tree from the parent node. As such, the CPU 12 may acquire such information in accordance with an input made by the operator, and stores the acquisition result in a memory for a temporary basis.

As shown in FIG. 27, first of all, the CPU 12 generates an insertion mark array for the receiving-side tree (step 2701)

FIG. 28 is a flowchart showing, in more detail, the process of generating the insertion mark array. As shown in FIG. 28, first of all, the CPU 12 reserves, in a memory, an area for the insertion mark array of the size same as the C-P array of the receiving-side tree (step 2801), and stores an initial value “0” as each element (step 2802). The CPU 12 initializes the processing target position to “0” (step 2803), and determines whether the value of the processing target position is the same as the node identifier immediately after the insertion position (step 2804). When the determination result in step 2804 is “No”, the CPU 12 refers to the value of the processing target position in the C-P array of the receiving-side tree, i.e., the node identifier of the parent node, and determines whether an element at the position indicated by the node identifier of the parent node is marked in the insertion mark array (i.e., whether the value is “1” or not) (step 2805).

When the determination result in step 2804 is “Yes”, or when the determination result in step 2805 is “Yes”, the CPU 12 sets “1” to the value of the processing target position in the insertion mark array (step 2806). The CPU 12 executes such a process with respect to every node identifier of the receiving-side tree (refer to steps 2807 and 2808).

FIG. 29 is a diagram showing an exemplary C-P array of a receiving-side tree, and an exemplary insertion mark array to be generated (in the drawing, denoted as “Insert Mark”). In this example, in the receiving-side tree, exemplified is a case where a received-side tree is inserted between the node under the node identifier “1” and the node under the node identifier “2”. As shown in the insertion mark array of FIG. 29, when the processing target positions are “0” and “1”, the determination is made as “No” in step 2804 and step 2805. On the other hand, when the processing target position is “2”, the determination is made as “Yes” in step 2804 because the value of “2” is the same as the node identifier immediately after the insertion position, and in the insertion mark array, the value of the storage position number “2” is set to “1” (refer to a reference numeral 2901).

When the processing target positions are “3” and “4”, the determination is made as “No” in step 2804 and step 2805. When the processing target position is “5”, in the C-P array, it is known that the value of the corresponding storage position number “5” is “2”, and the node identifier of the parent node is “2”. Because the value of the storage position number “2” is “1” in the insertion mark array, the CPU 12 determines “Yes” in step 2805. As such, in the insertion mark array, the value of the storage position number “5” is set to “1” (refer to a reference numeral 2902). The processing target positions “6” to “9” are subjected to the process similar thereto so that the eventual insertion mark array can be derived.

For each of the receiving-side tree and the received-side tree, the CPU 12 generates, in a memory, a level array for storing a level value indicating the depth of each of the nodes configuring the tree (step 2702). The nodes of same generation have the same level value. For example, in the receiving-side tree, for the node at the head of the C-P array (root node), the CPU 12 stores the level value “0” in the level array. For the remaining nodes, the CPU 12 specifies a parent node by referring to the C-P array, and then by referring to the level value of the parent node, the level value is added with “1” so that the level value is calculated for the node. Thereafter, the CPU 12 stores thus calculated level value at the corresponding position in the level array.

For the received-side tree, first of all, the CPU 12 executes a process similar to as described above, and goes through value storage into the level array. Thereafter, in the information temporarily stored in the memory indicating the position for inserting the vertex node of the received-side tree, the CPU 12 refers to the node identifier of the node in the receiving-side tree serving as a parent node for the vertex node in the received-side tree, and acquires the value of the level array corresponding to the node identifier (this is referred to as level value of parent node). Moreover, the CPU 12 adds “level value of parent node +1” to each value of the level array in the received-side tree. The resulting level array storing the level values after such addition is the level array for the received-side tree.

FIG. 30A is a diagram for illustrating the level array of the receiving-side tree. In FIGS. 30A and B, the level array is denoted as “Levels”. For the node at the head (root node of node identifier “0”), “0” is stored as a level value in the level array. For each of the two nodes thereafter (nodes of node identifiers “1” and “2”), the node identifier of the parent node is “0”, and the value “1” being the result of adding “1” to “0” is thus stored in the level array as the level value. FIG. 30B is a diagram for illustrating the level array of the received-side tree. The array denoted by a reference numeral 3010 is the array in the state through with the process similar to the receiving-side tree, and the array denoted by a reference numeral 3020 is the array in the eventual state after each level value is added with “level value of parent node +1”.

By referring to the C-P array of the receiving-side tree, the level array and the insertion mark array, and the C-P array and the level array of the received-side tree, the CPU 12 generates a new node identifier array for each of the trees (step 2703). FIGS. 31 and 32 are each a flowchart showing more in detail generation of new node identifiers. As shown in FIG. 31, the CPU 12 reserves, in a memory, an area for a new node identifier array of the size same as that of the C-P array for each of the received-side tree and the receiving-side tree (step 3101). The CPU 12 also reserves, in the memory, a current node identifier area (in the drawing, denoted as “Current Node No.”), stores an initial value “0” (step 3102) and initializes both of the processing target positions of the receiving-side tree and the received-side tree to “0” (step 3103).

The CPU 12 refers to the value of the processing target positions on the receiving-side in the insertion mark array (step 3104), and determines whether the value of the previous processing target position is “0”, and whether the value of the current processing target position is “1” (step 3105). Note that, in the first process, when the value of the insertion mark array is “1”, the determination result in step 3105 is “Yes”. When the determination result in step 3105 is “NO”, in the new node identifier array on the receiving-side, as the value for the processing target position on the receiving-side, the value of the current node identifier area is stored (step 3106).

On the other hand, when the determination result in step 3105 is “Yes”, the processing target is changed to the received-side tree. Note here that the level values in the level array of the received-side tree at the processing target position on the insertion side will be the same as the level values in the level array of the receiving-side tree at the processing target position on the inserted side.

More in detail, as shown in FIG. 32, the CPU 12 stores the value of the current node identifier area as the value at the processing target position on the insertion side in the new node identifier array on the insertion side (step 3201). Thereafter, the CPU 12 increments the value of the current node identifier area, and increments also the processing target position on the insertion side (step 3202). For the new processing target position on the insertion side, the CPU 12 refers to the values in the level array, and determines whether the values in the level array are changed or not (step 3203). When the value of the level array at the processing target position on the received-side before increment is the same as the value of the level array at the processing target position on the received-side after increment, the determination result in step 3203 is “No”, and the procedure returns to step 3201 for more processing. On the other hand, when the determination result in step 3203 is “Yes”, the procedure goes to step 3106.

When the processing is completed for the receiving-side tree and the received-side tree, i.e., when storage is completed for each of the new node identifier arrays, the determination to be made in step 3107 will be “Yes”. Other than that, the CPU 12 increments the value in the current node identifier area, and increments also the processing target position on the inserted side (step 3108).

By referring to FIGS. 33 to 37B, the processes of FIGS. 31 and 32 are described more specifically. FIG. 33 shows the state that the area of the new node identifier array and the current node identifier area storing the initial value “0” are stored in the memory. Moreover, for both of the receiving-side tree and the received-side tree, the processing target position is “0”.

As shown in FIG. 34A, when the processing target position on the inserted side is “0”, the value of the position is “0” in the insertion mark array, and in the new node identifier array on the inserted side, as the value of the storage position number “0”, the value “0” of the current node identifier area is stored. Thereafter, the value of the current node identifier area is incremented so that the value becomes “1”.

As shown in FIG. 34B, also when the processing target position on the inserted side is “1”, the value at the position in the insertion mark array is “0”, and there is no change as the value “0” of the insertion mark array of FIG. 34A. As such, in the new node identifier array on the inserted side, as the value of the storage position number “1”, the value “1” of the current node identifier area is stored. Thereafter, the value of the current node identifier area is incremented so that the resulting value becomes “2”.

As shown in FIG. 35A, when the processing target position on the inserted side is “2”, the value at the position in the insertion mark array is “1”, which is changed from the value “0” of the insertion mark array of FIG. 34B. As such, the determination in step 3105 is made as “Yes”. Accordingly, the procedure moves to the process related to the received-side tree, and in the new node identifier array on the insertion side, as the value of the storage position number “0”, the value “2” of the current node identifier area is stored. Thereafter, the value of the current node identifier area is incremented so that the resulting value is “3”, and the processing target position on the insertion side is also incremented so that the resulting value is “1”. Here, in the level array, the value of the processing target position “1” on the insertion side is “2”, which is not the same as the value “1” of the level array of the processing target position “0” before increment. As such, the procedure goes to the process of step 3106 of FIG. 31, and in the new node identifier array, as the value of the processing target position “2” on the inserted side, the value “3” of the current node identifier area is stored. Thereafter, the value of the current node identifier area is incremented so that the resulting value becomes “4” (refer to FIG. 35B).

As shown in FIGS. 36A and B, when the processing target positions on the inserted side are “3” and “4”, value storage is made to the new node identifier array on the inserted side. As shown in FIG. 37A, when the processing target position on the inserted side is “5”, the value of the insertion mark array is changed to “1”. Therefore, a value is stored in the new node identifier array on the received side this time, and thereafter, another value is stored in the new node identifier array on the receiving-side.

By repeating such a process, as shown in FIG. 37B, on both receiving-side and received-side, the resulting new node identifier array carries therein any new node identifier as a result of insertion of tree.

Next, the CPU 12 generates, in the memory, the C-P array for the receiving-side tree and that for the received-side tree based on the new node identifier array (step 2704). For acquiring the C-P array for each of those, the receiving-side tree and the received-side tree may be each subjected to the process similar to the process of FIG. 21. In actuality, there is no need to execute the storage address calculation process, and by performing the calculation of the node identifier of a parent node (steps 2106 to 2108 of FIG. 21), the CPU 12 can derive the C-P array for the receiving-side tree and that for the received-side tree. Note that, herein, a correlation is established in advance between each of values in the parent node identifier array and values at the storage position same as those in the new node identifier array.

FIG. 38A is a diagram showing the state of the receiving-side when any new C-P array is derived, and FIG. 38B is a diagram showing the state on the received-side when any new C-P array is derived. Note that, in FIG. 38B, for the received-side, the CPU 12 executes the processes of steps 2106 to 2108 of FIG. 21 so that any new C-P array (refer to a reference numeral 3801) is derived. Thereafter, for a root node (node with the value “−1” in the C-P array), the CPU 12 stores the node identifier (“0” in this example) of a node that will serve as a parent node at the time of insertion (refer to a reference numeral 3802).

Moreover, the CPU 12 merges the new C-P array of the receiving-side tree with that of the received-side tree, thereby generating a C-P array after insertion (step 2705). As shown in FIG. 39, in the C-P array newly generated for the receiving-side (refer to a reference numeral 3901), there is no value for a portion where the node identifier of the parent node in the received-side tree is supposed to be, and on the other hand, also in the C-P array newly generated for the received-side (refer to a reference numeral 3902), there is no value for a portion where the node identifier of the parent node in the receiving-side tree is supposed to be. As such, if an array is generated by mutually utilizing the portions where values being not a null value are stored, the result will be a C-P array after insertion (refer to a reference numeral 3910).

FIG. 40A is a diagram showing a receiving-side tree before insertion of a received-side tree. With the C-P array under the reference numeral 3910 of FIG. 39, the tree of FIG. 40A is inserted with a received-side tree, thereby deriving, schematically, such a topology as shown in FIG. 40B. Needless to say, this is in accordance with the width-first mode described above.

[Actual Data Management]

As described above, according to the embodiment, when a tree data structure is represented in the width-first mode, a C-P array is generated in such a manner that a tree data structure is represented also in the state that a receiving-side tree is inserted with a received-side tree with the width-first mode. In this process, the node identifier is changed for each node. In actuality, as described by referring to FIGS. 2A and B, in the tree data structure, every node configuring a tree is correlated with a node type and a node value. The node type is not essential, but is provided for indicating the meaning of the value of the node (e.g., in FIG. 2B, a value “France Shop” is indicating it as “shop name”)

FIG. 41A is a diagram schematically showing a receiving-side tree exemplified in FIG. 26A and the like. FIG. 41B is a diagram showing an exemplary C-P array stored in a memory indicating the receiving-side tree, and an exemplary storage array for node values stored in the memory with a correlation with each node identifier. As shown in FIG. 41B, in this example, a node is stored only with a node value of “parts name” (in the drawing, denoted as “PARTS-NAME”), and is not provided with a node type. Also in FIG. 41A, the node value is described together with a node identifier. The exemplary tree is of parts of a toy plane (TOY PLANE), and each node represents a parts name.

Similarly, FIG. 42A is a diagram schematically showing a received-side tree exemplified in FIG. 26A and the like. FIG. 42B is a diagram showing an exemplary C-P array stored in a memory indicating the received-side tree, and an exemplary storage array for node values stored in the memory with a correlation with each node identifier. Also in FIG. 42A, a node value is described together with a node identifier.

By the tree insertion process in the embodiment, a new C-P array is generated. The CPU 12 refers to the receiving-side and received-side new node identifier arrays shown in FIGS. 38A and B, respectively, thereby being able to understand what node identifier is newly provided as the node identifier in the receiving-side tree to the tree structure after insertion, and what node identifier is newly provided as the node identifier in the received-side tree to the tree structure after insertion. As such, the CPU 12 generates not only a new C-P array but also a storage array storing node values correlated to any new node identifier. FIG. 43A is a diagram schematically showing a tree after insertion, and FIG. 43B is a diagram showing a C-P array newly stored in a memory and a storage array of node values newly stored in the memory.

As shown in FIG. 43B, when a storage array is generated for any new node values, the CPU 12 specifies the insertion position for the storage array of the node values of the receiving-side tree, and at the insertion position, any insertion value of the storage array may be inserted for the node values in the received-side tree. Alternatively, the CPU 12 may execute a process of newly reserving an area for a storage array of the node values in a memory, and at the position corresponding to any new node identifier, storing either the value of the storage array of the node values of the receiving-side tree or a value of the storage array of the node values of the received-side tree.

Also at the time of deletion of subtree, similarly, the CPU 12 refers to the new node identifier array (refer to FIG. 20), after deletion of subtree, so that a new node identifier can be known for each of any remaining nodes as a result of deletion. As such, the CPU 12 can delete the value at the deletion position from the storage array of the node values. Alternatively, the CPU 12 may execute a process of newly reserving an area for a storage array in the memory, and at the position corresponding to the new node identifier, storing the value of the previous storage array.

[Function Block Diagram]

FIG. 44 is a function block diagram of an information processing device constructing a tree data structure of the embodiment of the present invention. As shown in FIG. 44, an information processing device 4400 is configured to include a storage part 4401 for storing data representing a tree data structure, a tree definition part 4402 for generating a C-P array representing a tree data structure and storing the C-P array into the storage part, a tree insertion processing part 4403, and a tree deletion processing part 4404.

The tree insertion processing part 4403 reads out a C-P array and the like of a tree to be processed from the storage part 4401 based on information specifying a receiving-side tree and a received-side tree input through operation of an input unit (not shown in FIG. 44) by an operator, and information specifying the insertion position. The C-P array representing the tree data structure after insertion is thus generated, and the resulting C-P array is stored in the storage part 4401. Moreover, the tree insertion processing part 4403 updates the storage array of node values in accordance with the insertion of tree, or generates any new storage array in accordance with the insertion of tree.

The tree deletion processing part 4404 reads out, from the storage section 4401, a C-P array to be processed and the like based on the node identifier for a vertex node in a subtree to be deleted, which has been input through operation of an input unit by an operator. The C-P array representing the tree data structure after deletion of the subtree is thus generated, and the resulting C-P array is stored in the storage part 4401. Moreover, the tree deletion processing part 4404 updates the storage array of node values in accordance with the deletion of subtree, or generates any new storage array in accordance with the deletion of subtree.

In this embodiment, the node identifier uniquely assigned to the node is a sequence of integers assigned by giving a priority to nodes of same generation over child nodes. Moreover, for each of the receiving-side tree and the received-side tree, the parent-child relationship among nodes is represented by an array C-P array) containing node identifiers assigned to each parent node of non-root nodes being associated with an order of a node identifier assigned to each of the non-root nodes. The tree definition part 4402 reads out data about a tree in the format of XML stored in the storage section 4401 or any other storage devices, for example, and assigns a node identifier to the nodes configuring the tree. For each of the node identifiers, the C-P array containing the node identifier of the parent node of the node is stored in the storage part 4401. Moreover, in the data about the tree in the format of XML, the tree defining section 4402 generates a storage array in which the actual data correlated to each of the nodes (node type and node value) is stored in association with the node identifier, and stores the result in the storage section 4401.

Needless to say, the present invention is not restricted to the embodiment described above, and numerous other modifications can be devised without departing from the scope of claims of the present invention, and these are also included in the scope of the present invention.

In the embodiment, for example, deletion of tree is applied to the structure in which a tree data structure is represented with the width-first mode with which nodes of same generation are given a higher priority over child nodes. That is, from the parent-child relationship definition array (C-P array) related to node identifiers assigned to each node based on the width-first mode, a new C-P array is generated in accordance with the width-first mode after deletion of segment of tree. However, deletion of tree according to the present invention is applicable also to the structure in which a tree data structure is represented with the depth-first mode with which child nodes are given a higher priority over nodes of same generation.

FIG. 45 is a diagram showing an exemplary tree data structure represented with the depth-first mode. This is the same as the topology of the tree data structure of FIG. 15. In the below, in the tree data structure of FIG. 45, exemplified is a case of deleting a subtree whose vertex node is the node denoted by a reference numeral 4501.

FIG. 46 is a diagram showing an array representing the parent-child relationship in the tree data structure of FIG. 45 (C-P array), a delete flag array storing an initial value, a new node identifier array, and a current node identifier area storing the initial value. This is corresponding to FIG. 17 with the width-first mode. The delete flag array in FIG. 46 is the one at the time when step 1602 of FIG. 16 is executed.

FIG. 47 is a diagram for illustrating the process of tree deletion with the depth-first mode, and shows the state of delete flag array, the new node identifier node, and the current node number at the time when the process of FIG. 16 is completed.

FIGS. 48A and 48B respectively show the storage address array and the parent node identifier array when the process of FIG. 21 is executed, and FIG. 48C is a diagram showing a new C-P array with the depth-first mode derived by execution of step 2111 of FIG. 21 after deletion of subtree. The topology of the tree data structure based on the C-P array will look like the one in FIG. 49B. Compared with FIG. 49A showing the tree data structure before deletion of subtree, it is known that the subtree whose vertex mode is the node under the reference numeral 4501 is deleted.

Note that the method of deletion of tree of the present invention is applicable to the case other than the width-first mode or the depth-first mode described above. In actuality, the method of deletion of tree of the present invention can be applied when a node is assigned a node identifier and a parent-child relationship array (C-P array) containing a parent node of each of nodes is stored in a storage device under conditions that:

1. node identifiers are consecutive integers starting from an initial value, and

2. a node identifier of a parent node is smaller than a node identifier of a child node in case of the parent node and the child node have a parent-child relationship.

### BRIEF DESCRIPTION OF THE DRAWINGS

FIG. 1 is a block diagram showing the hardware structure of an information processing device handling a tree data structure in an embodiment of the present invention.

FIGS. 2A and 2B are each a diagram illustrating POS data being exemplary tree-form data, and FIG. 2A is an example of visually representing the data structure (i.e., topology) and the data value of this tree-form data, and FIG. 2B is an example of representing the same tree-form data in the XML format.

FIGS. 3A to 3C are each a diagram illustrating an exemplary representation format of the tree-form data structure using an arc list.

FIGS. 4A to 4C are each a diagram illustrating a method of representing the tree data structure based on a “child→parent” relationship in an embodiment of the present invention.

FIG. 5 is a flowchart of a method of constructing a tree data structure on a storage device in an embodiment of the present invention.

FIGS. 6A to 6C are each a diagram illustrating a process of converting tree structure data in the ID format into tree structure data in the format of sequence of integers in accordance with an embodiment of the present invention.

FIGS. 7A to 7C are each a diagram illustrating a process of converting tree structure data in the ID format into tree structure data in the format of sequence of integers by another embodiment of the present invention.

FIG. 8 is a flowchart of a node defining process based on a depth-first in an embodiment of the present invention.

FIG. 9 is a diagram illustrating an array of a parent-child relationship based on the “child→parent” representation created in an embodiment of the present invention.

FIG. 10 is a diagram illustrating an array of parent-child relationship based on the “parent→child” representation created from the tree data structure with a depth-first shown in FIG. 6C.

FIG. 11 is a flowchart of a node defining process based on a width-first in an embodiment of the present invention.

FIG. 12 is a diagram illustrating an array of parent-child relationship based on the “child→parent” representation created in an embodiment of the present invention.

FIG. 13 is a diagram illustrating an array of a parent-child relationship based on the “parent→child” representation created from the tree data structure with a depth-first shown in FIG. 7C.

FIG. 14 is a diagram showing the relationship about mutual conversion among three representation formats in an embodiment of the present invention.

FIG. 15 is a diagram schematically showing an exemplary tree data structure represented with a width-first mode according to an embodiment.

FIG. 16 is a flowchart showing the first half of a tree deletion process (tree deletion process 1) according to an embodiment.

FIG. 17 is a diagram showing an array representing the parent-child relationship of the tree data structure of FIG. 15, a delete flag array storing an initial value, a new node identifier array, and a current node identifier area storing an initial value.

FIGS. 18A and 18B are each a diagram illustrating a tree deletion process according to an embodiment.

FIGS. 19A and 19B are each another diagram illustrating a tree deletion process of according to an embodiment.

FIG. 20 is a diagram illustrating a tree deletion process of according to an embodiment.

FIG. 21 is a flowchart showing a process for generating a C-P array after deletion of tree (tree deletion process 2).

FIGS. 22A to 22D are each a diagram illustrating, in detail, processes to be executed in step 2103 and step 2104.

FIGS. 23A to 23D are each a diagram illustrating, in detail, processes to be executed in steps 2106 to 2108.

FIGS. 24A and 24B are diagrams respectively showing an exemplary storage address arrays as a result of the processes of FIGS. 22A to 22D and an exemplary parent node identifier array as a result of the processes of FIGS. 23A to 23D, and

FIG. 24C is a new C-P array derived based on the storage address array and the parent node identifier array.

FIG. 25A is a diagram visually showing an exemplary tree data structure same as that of FIG. 15, and FIG. 25B is a diagram visually showing the tree data structure based on the C-P array of FIG. 24C.

FIGS. 26A and 26B are diagrams respectively showing exemplary receiving-side tree and received-side tree according to an embodiment.

FIG. 27 is a flowchart showing the outline of insertion of tree according to an embodiment.

FIG. 28 is a flowchart showing, more in detail, a process of generating an insertion mark array.

FIG. 29 is a diagram showing an exemplary C-P array of the receiving-side tree, and an exemplary insertion mark array to be generated.

FIGS. 30A and 30B are respectively showing a level array of the receiving-side tree and that of the received-side tree.

FIG. 31 is a flowchart showing, more in detail, generation of a new node identifier.

FIG. 32 is another flowchart showing, more in detail, generation of a new node identifier.

FIG. 33 is a diagram specifically illustrating generation of a new node identifier.

FIGS. 34A and 34B are each another diagram specifically illustrating generation of a new node identifier.

FIGS. 35A and 35B are each still another diagram specifically illustrating generation of a new node identifier.

FIGS. 36A and 36B are each still another diagram specifically illustrating generation of a new node identifier.

FIGS. 37A and 37B are each still another diagram specifically illustrating generation of a new node identifier.

FIG. 38A is a diagram showing the state on a receiving-side where a new C-P array is derived, and FIG. 38B is a diagram showing the state of a received-side when a new C-P array is derived.

FIG. 39 is a diagram showing a C-P array after insertion of a received-side tree.

FIG. 40A is a diagram visually showing a receiving-side tree before insertion of a received-side tree, and FIG. 40B is a diagram visually showing a tree after insertion of the received-side tree.

FIG. 41A is a diagram schematically showing an receiving-side tree, and FIG. 41B is a diagram showing an exemplary C-P array stored in a memory for representing the receiving-side tree, and an exemplary storage array of node values stored in the memory with a correlation with each corresponding node identifier.

FIG. 42A is a diagram schematically showing a received-side tree, and FIG. 42B is a diagram showing an exemplary C-P array stored in a memory for representing the received-side tree, and an exemplary storage array of node values stored in the memory with a correlation with each corresponding node identifier.

FIG. 43A is a diagram schematically showing a tree after insertion, and FIG. 43B is a diagram showing a new C-P array stored in a memory, and a storage array of new node values stored in the memory.

FIG. 44 is a functional block diagram of an information processing device constructing a tree data structure in an embodiment of the present invention.

FIG. 45 is a diagram showing an exemplary tree data structure represented with a depth-first mode according to an embodiment.

FIG. 46 is a diagram showing an array representing a parent-child relationship of the tree data structure shown in FIG. 45, a delete flag array containing an initial value, a new node identifier array, and a current node identifier area containing an initial value.

FIG. 47 is a diagram illustrating a tree deletion process with the depth-first mode.

FIGS. 48A and 48B are diagrams respectively showing an exemplary storage address array as a result of the processes of FIGS. 22A to 22D, and an exemplary parent node identifier array as a result of the processes of FIGS. 23A to 23D, and

FIG. 48C is a diagram showing a C-P array after deletion of a subtree.

FIGS. 49A and 49B are each a diagram illustrating a tree deletion process with the depth-first mode.

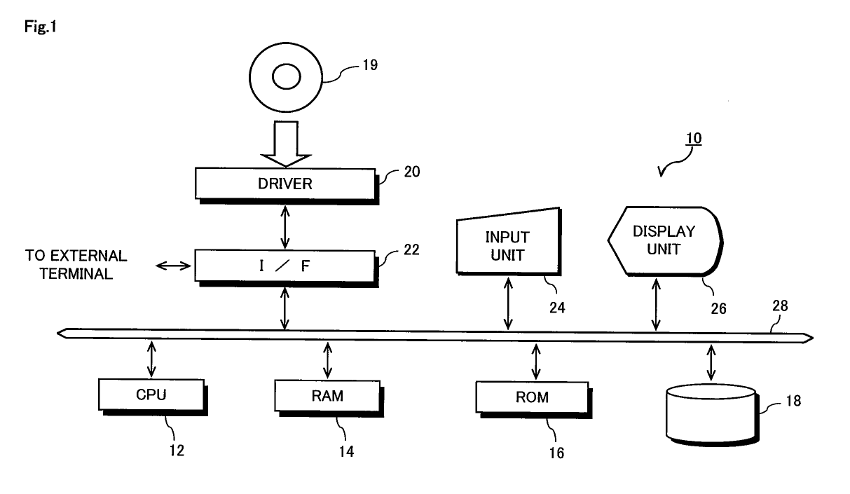

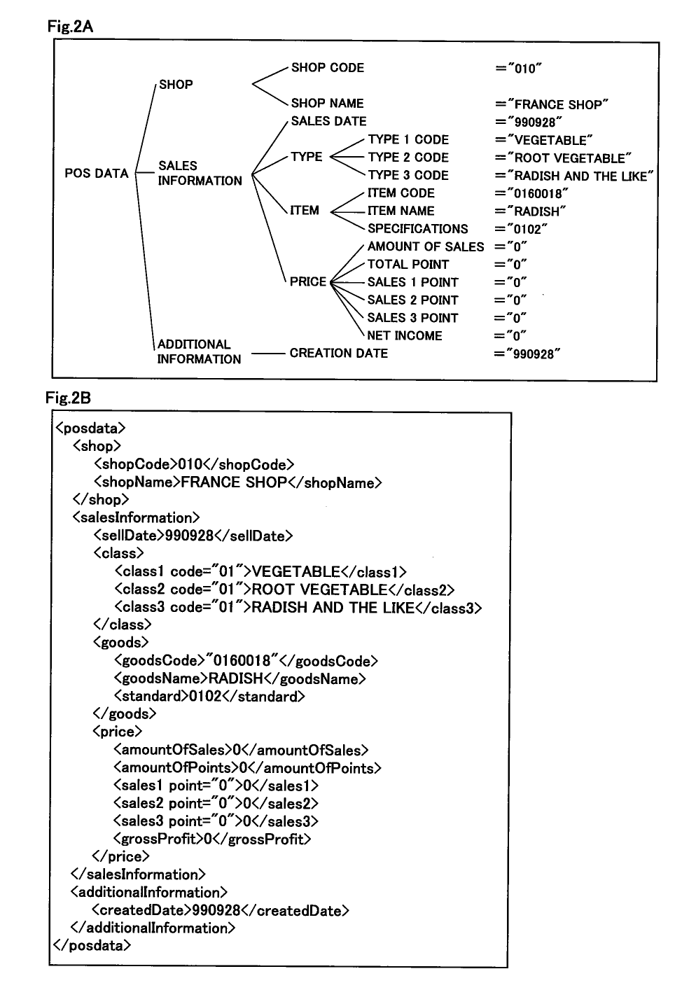

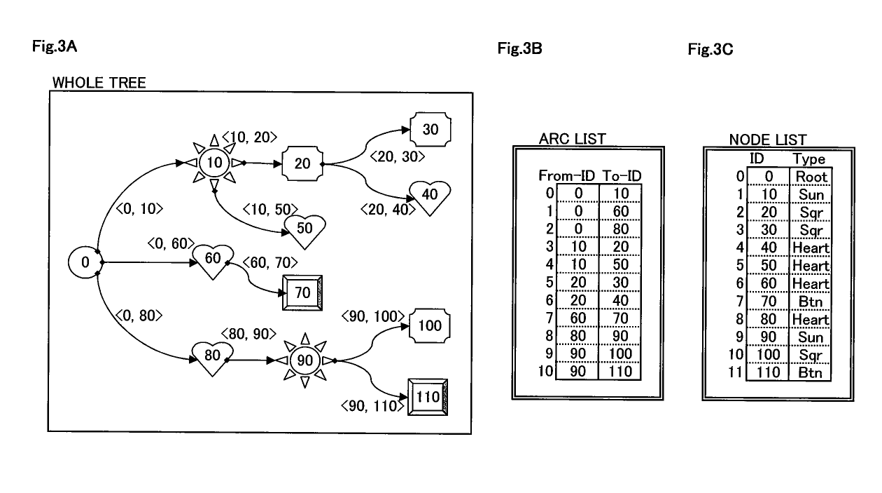

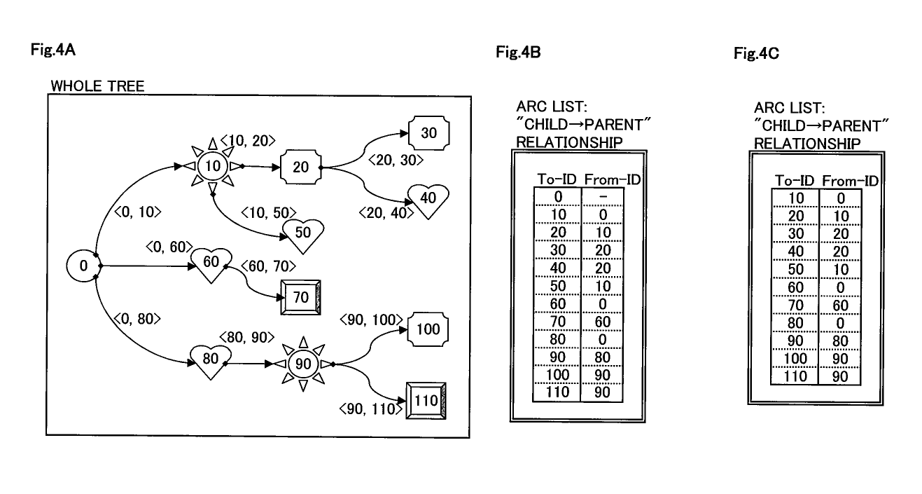

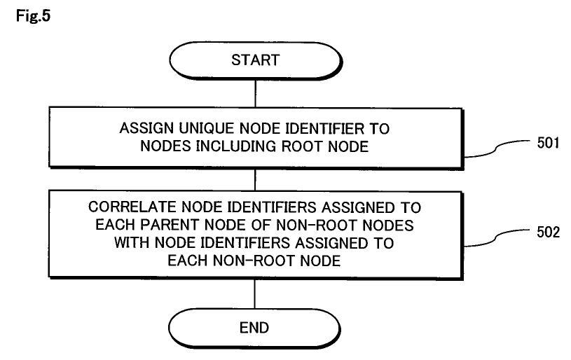

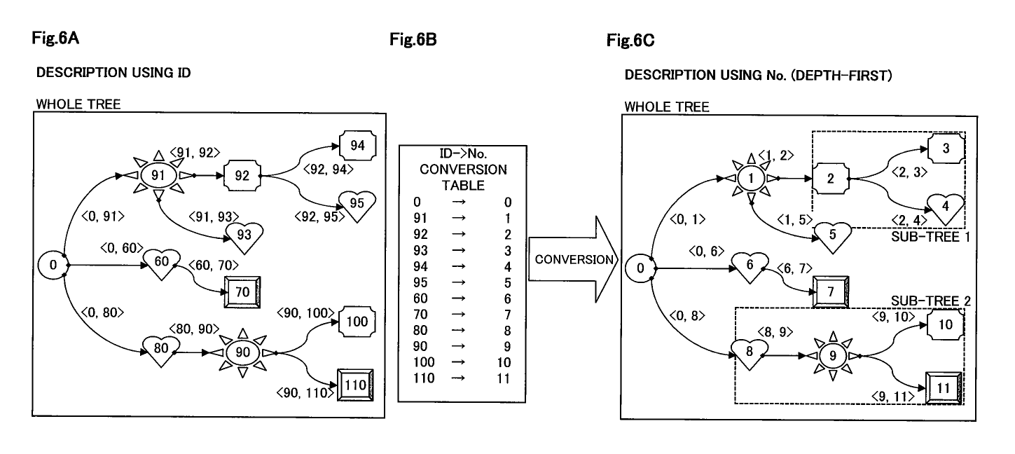

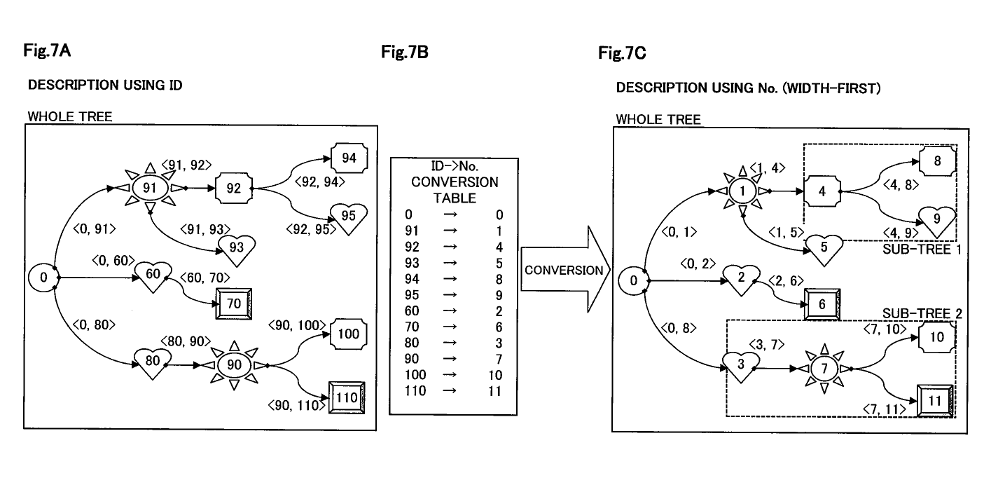

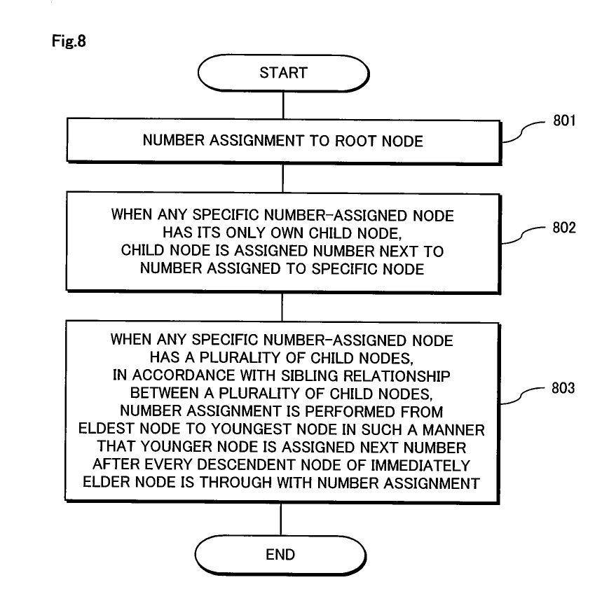

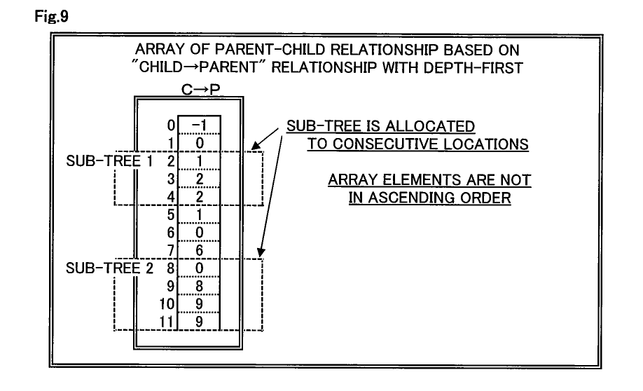

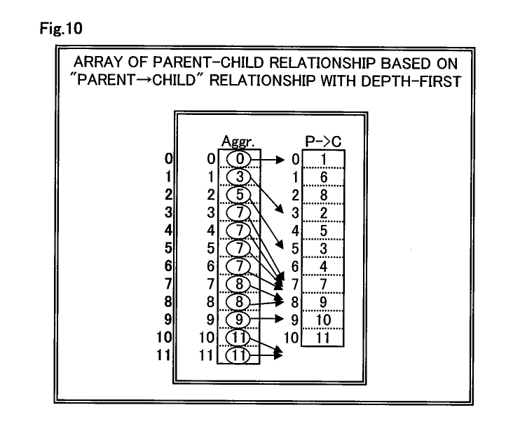

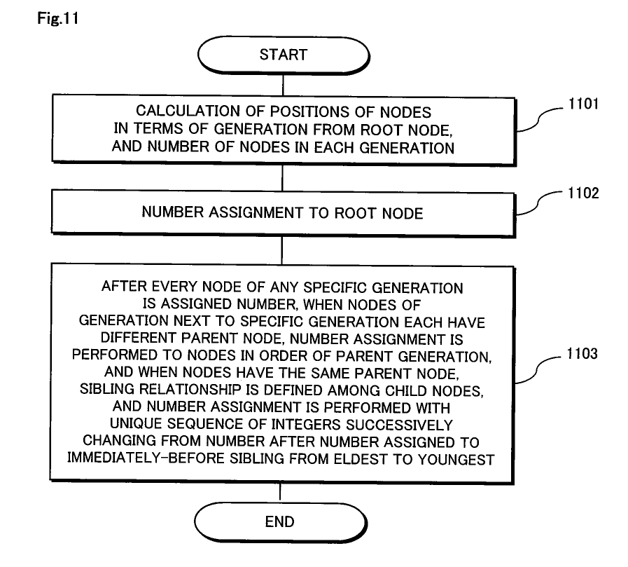

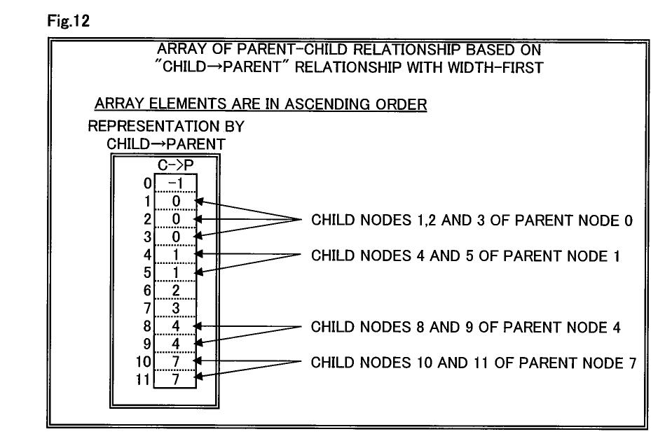

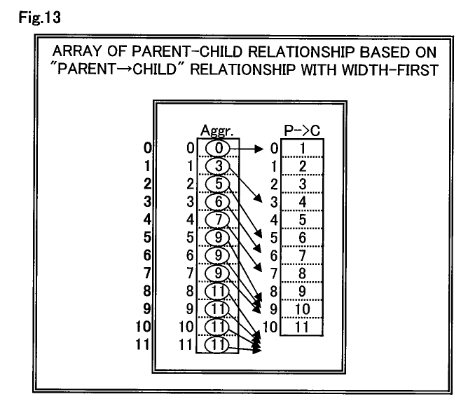

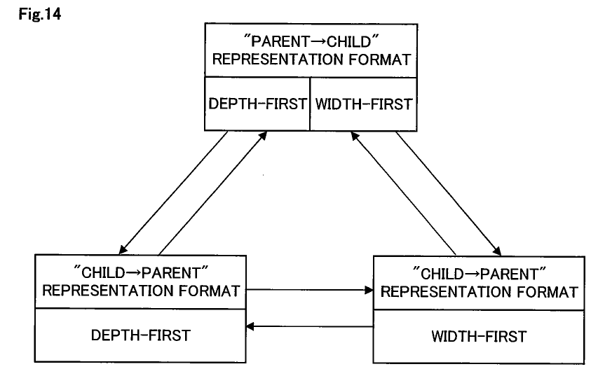

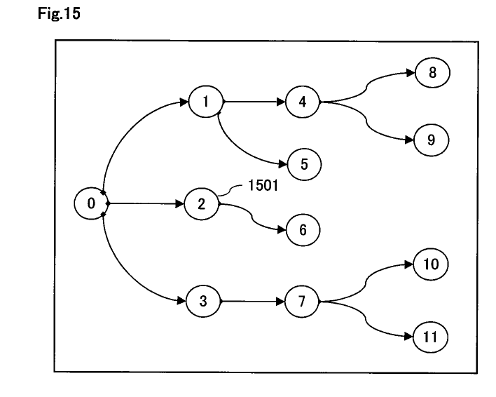

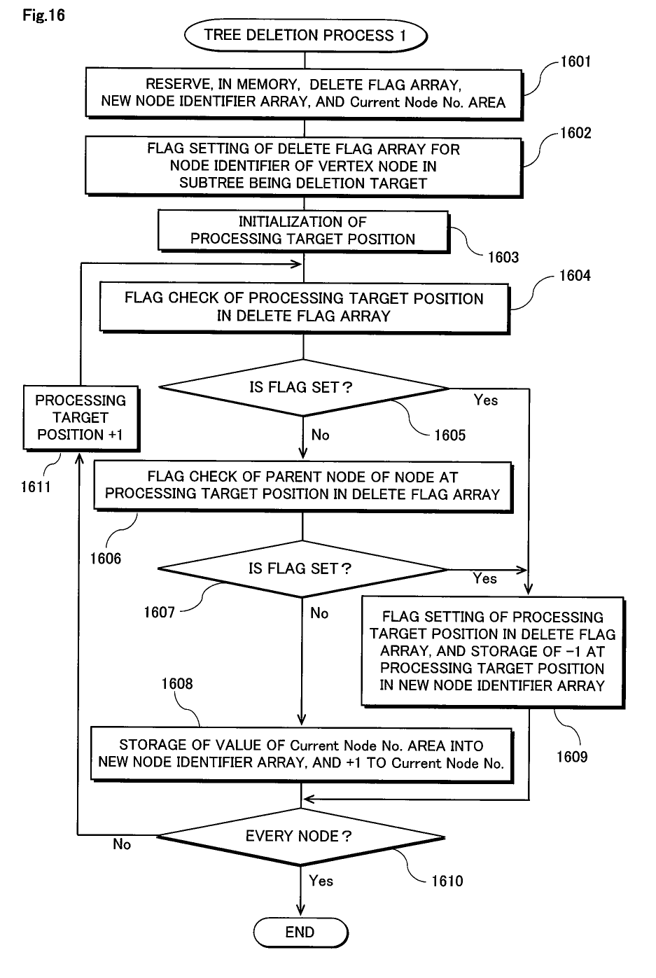

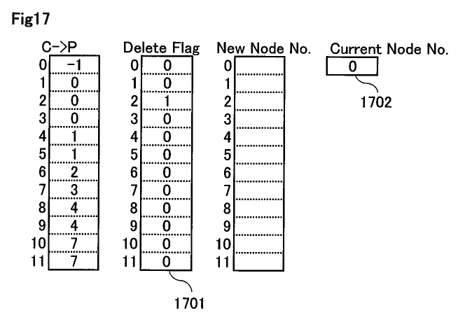

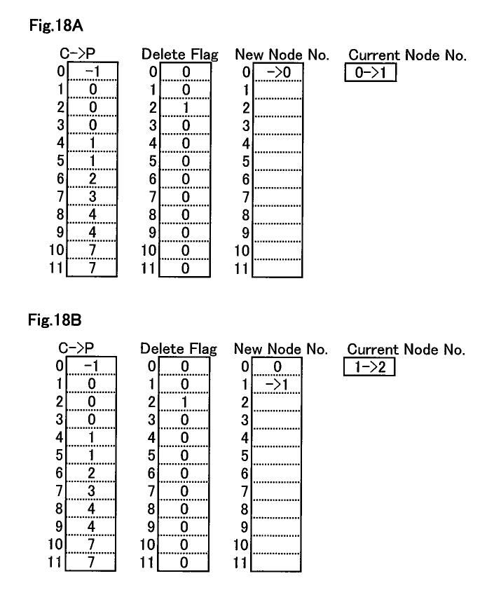

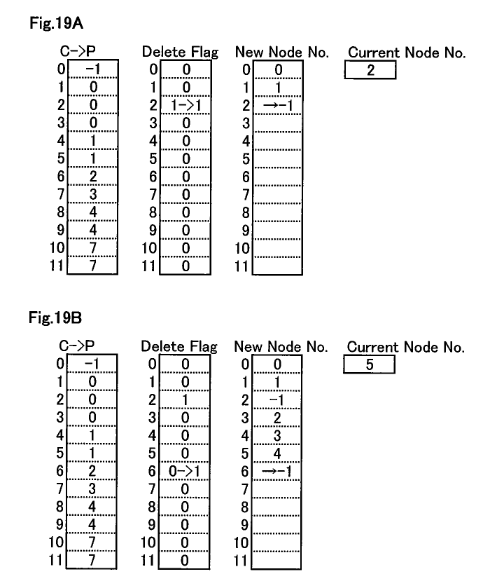

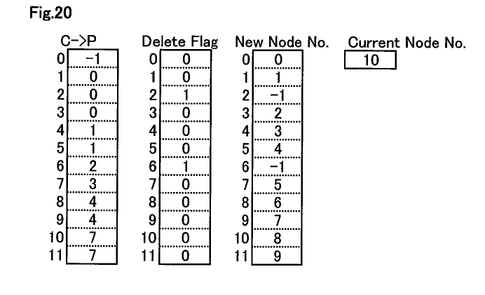

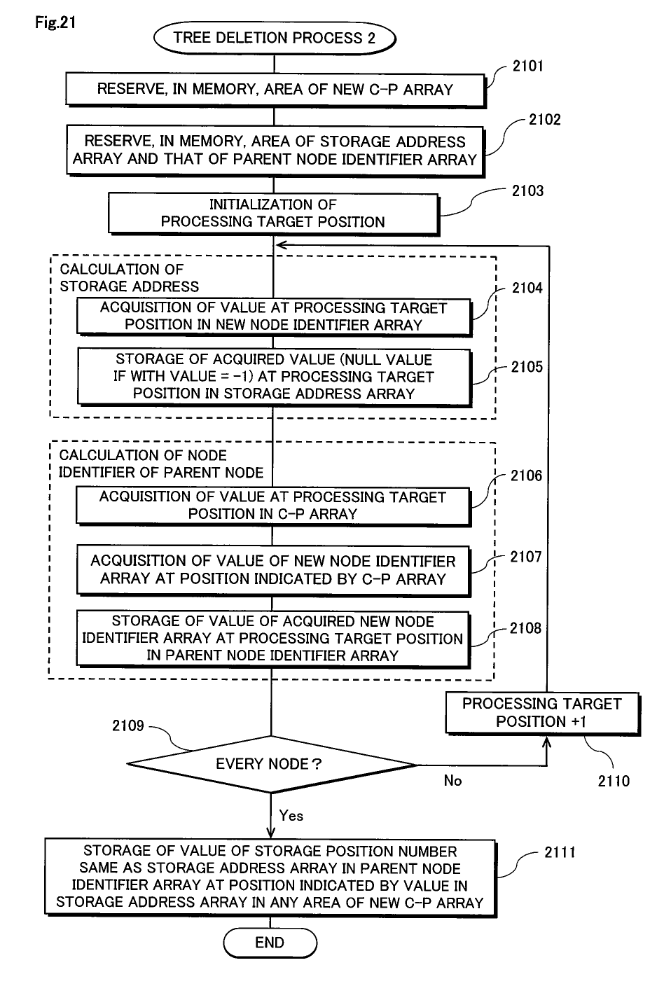

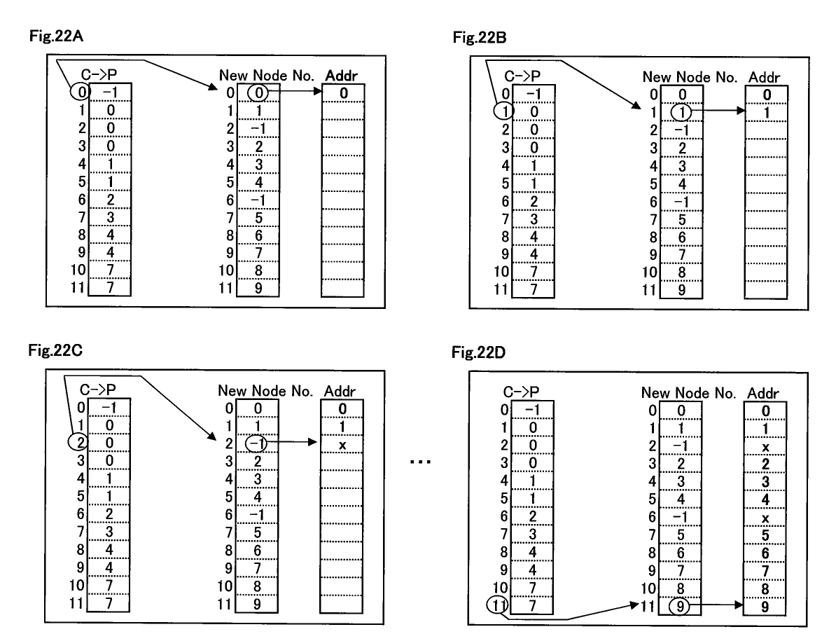

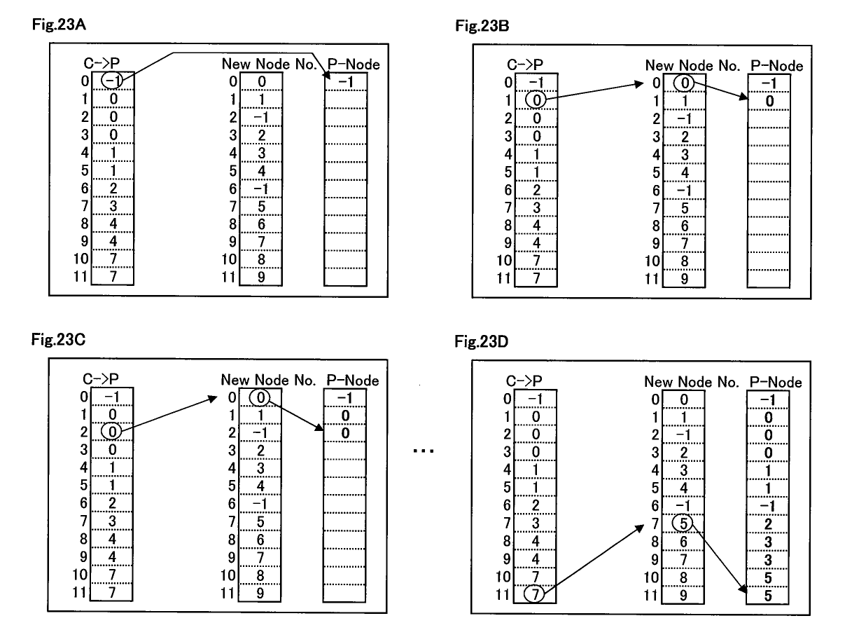

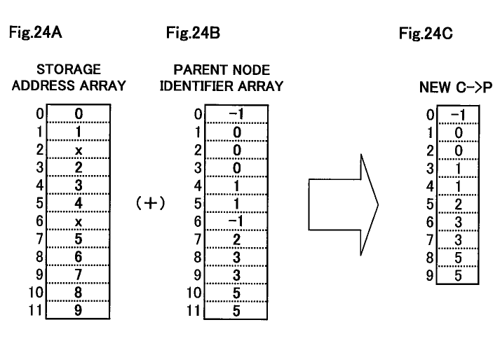

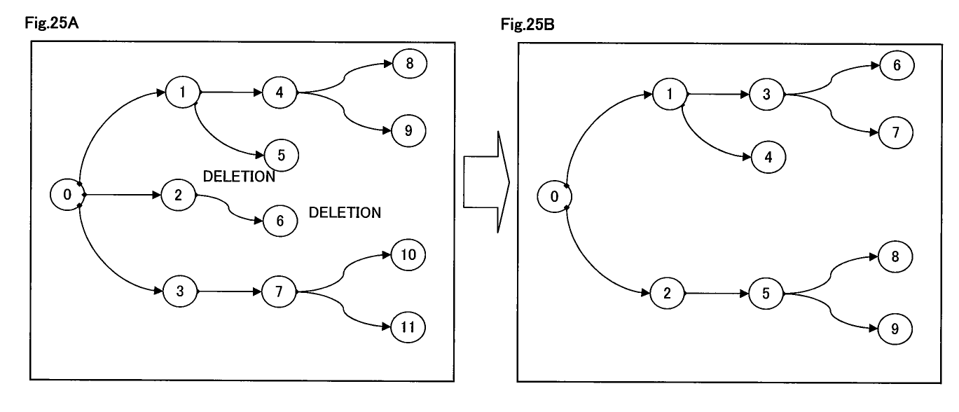

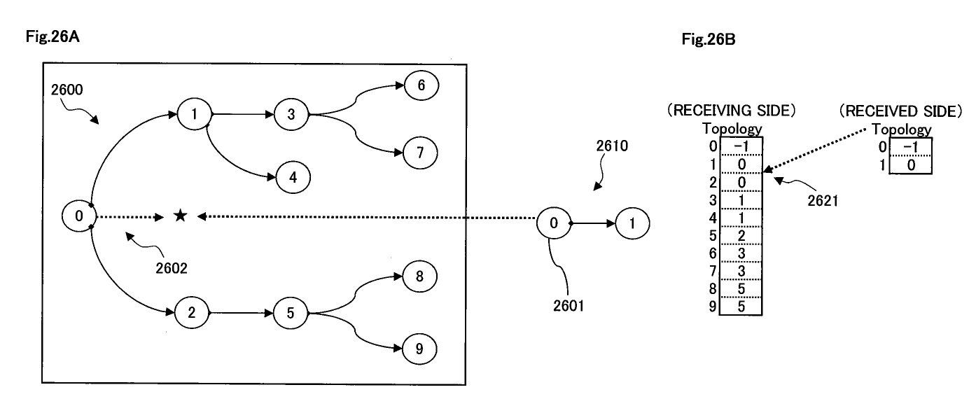

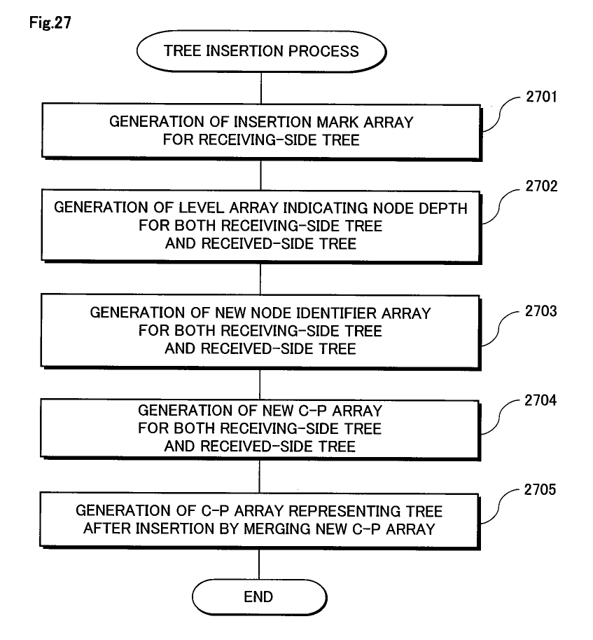

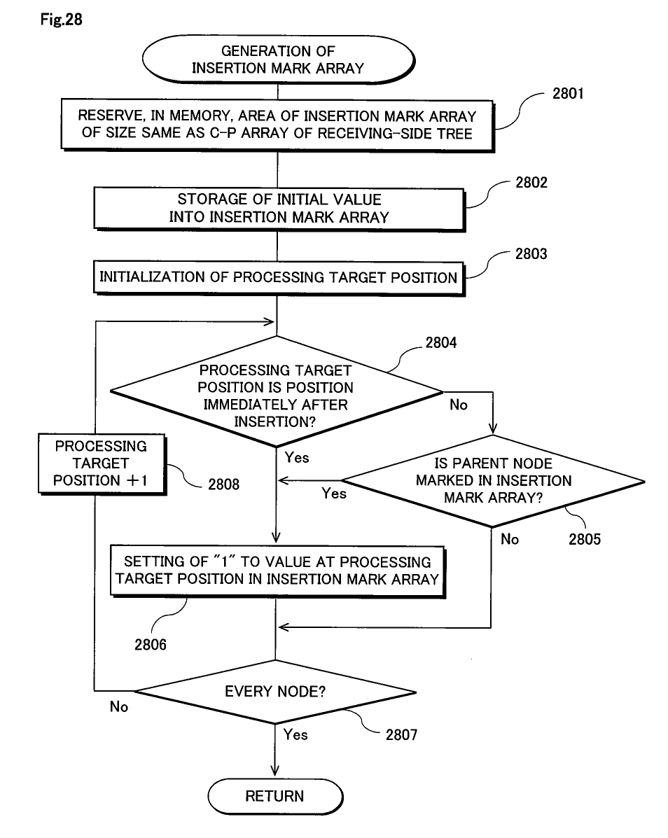

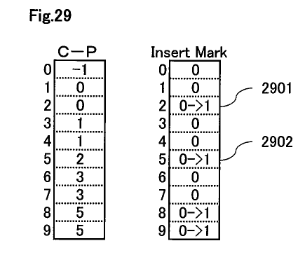

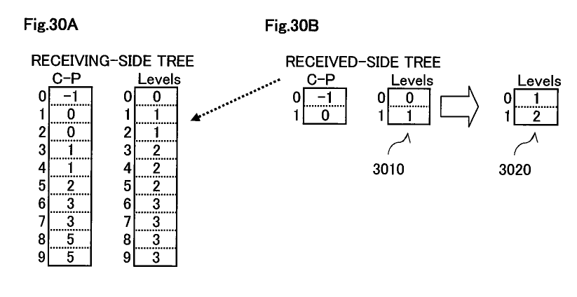

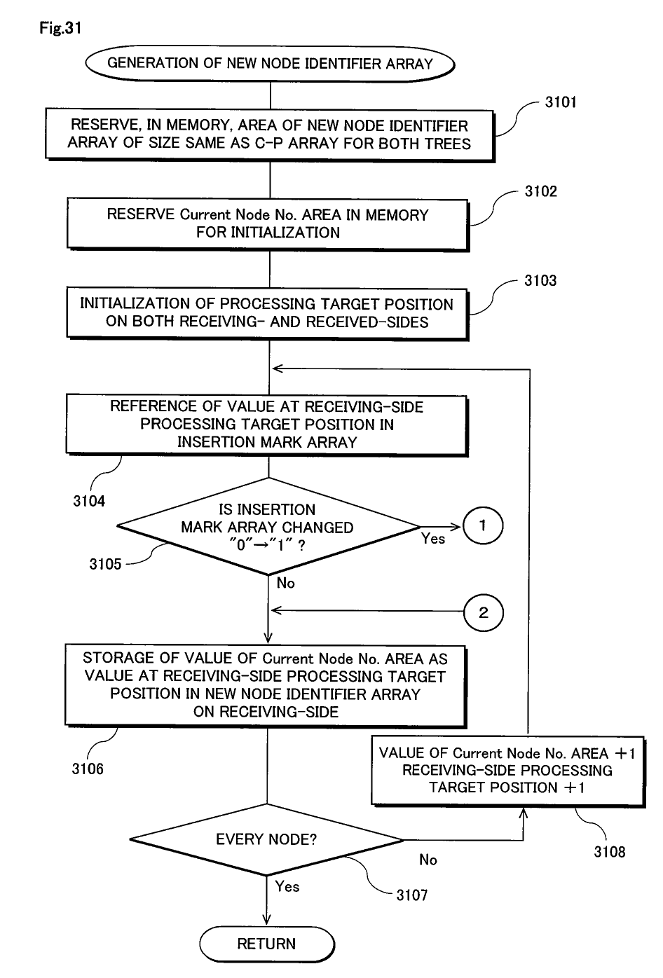

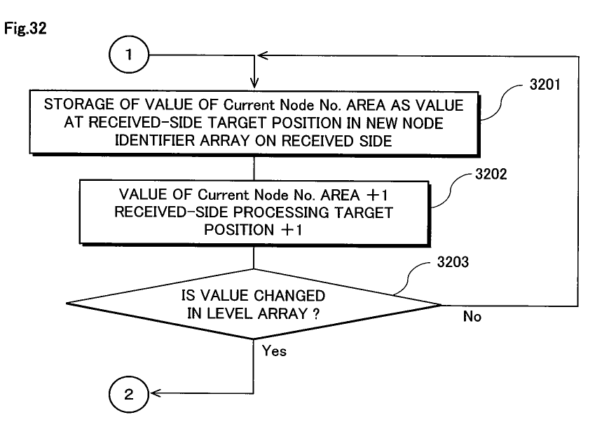

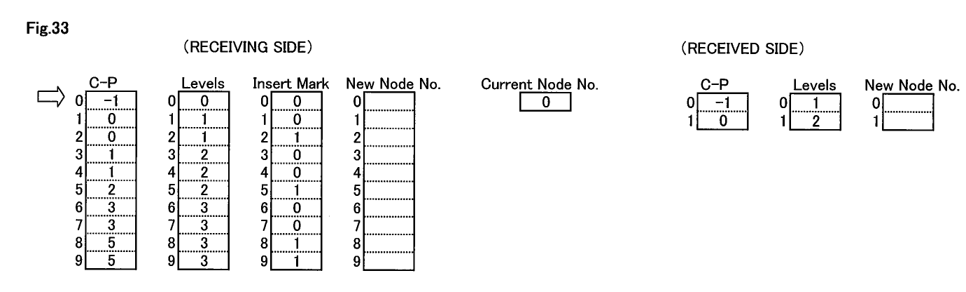

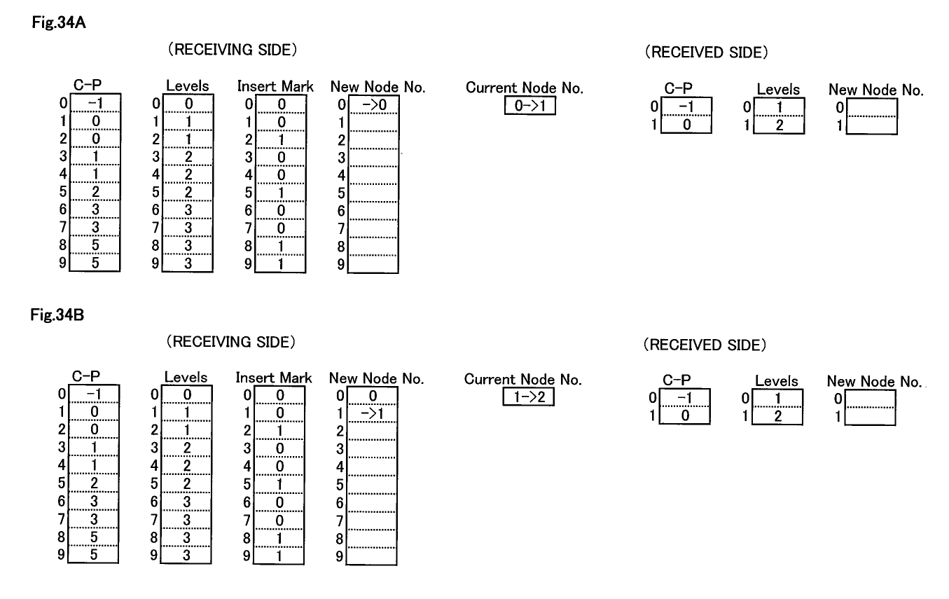

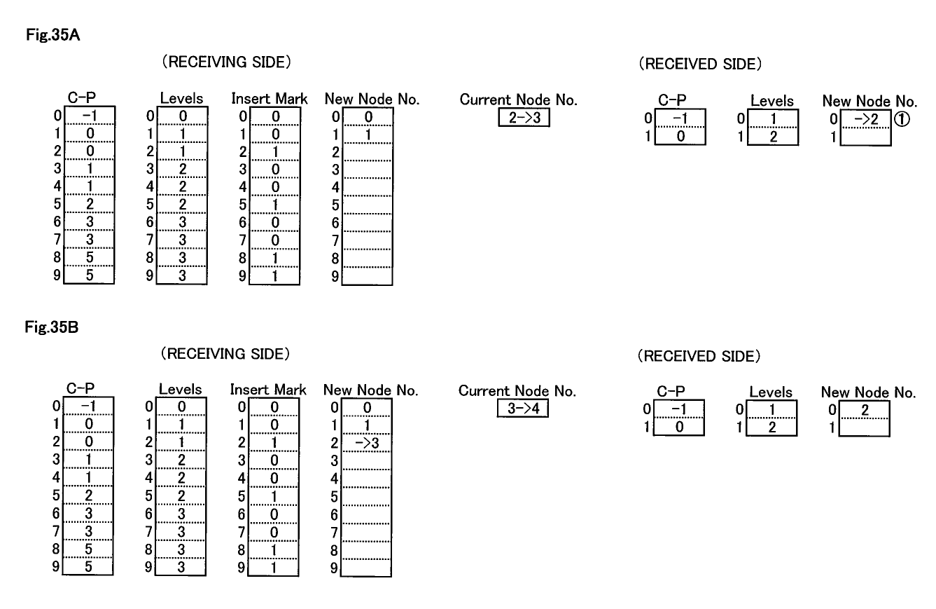

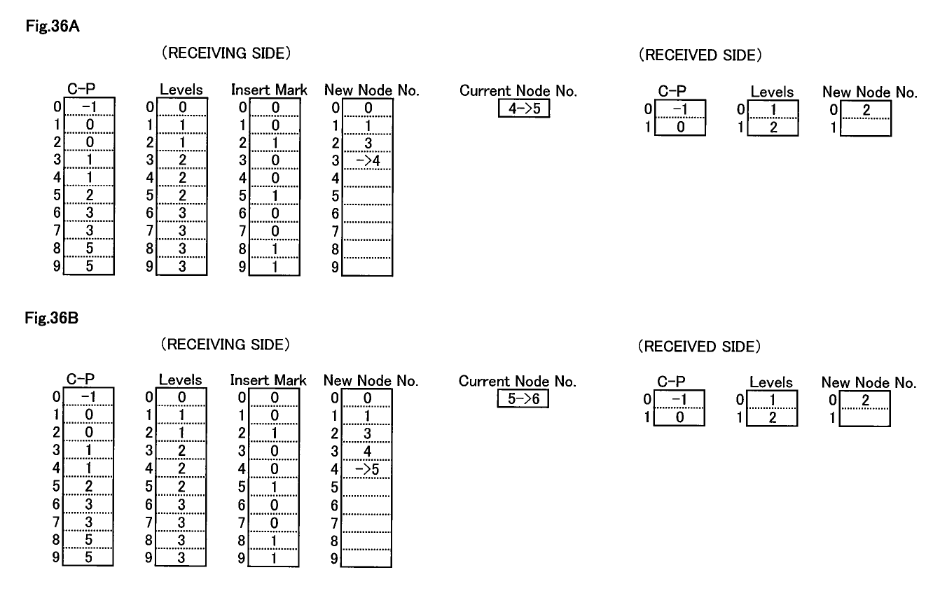

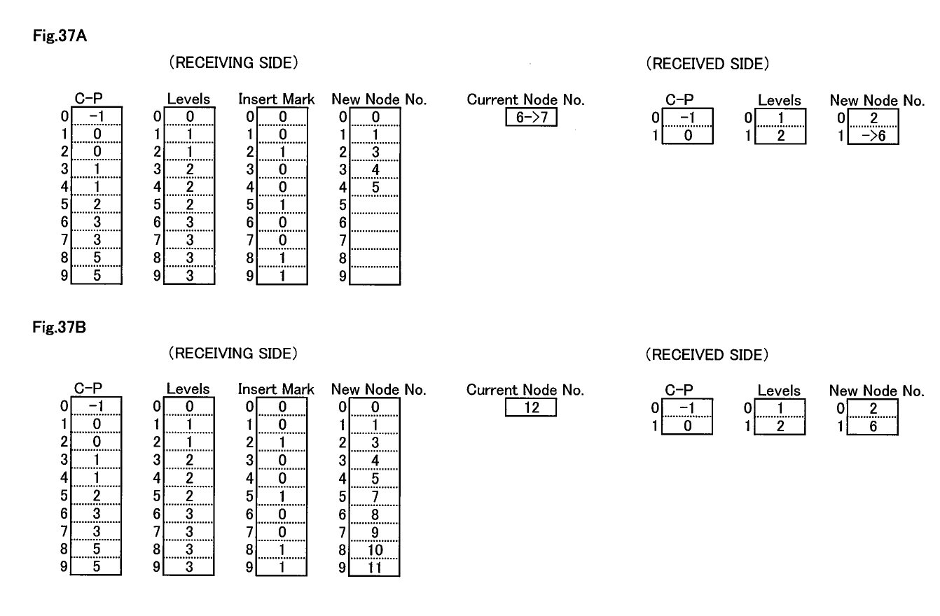

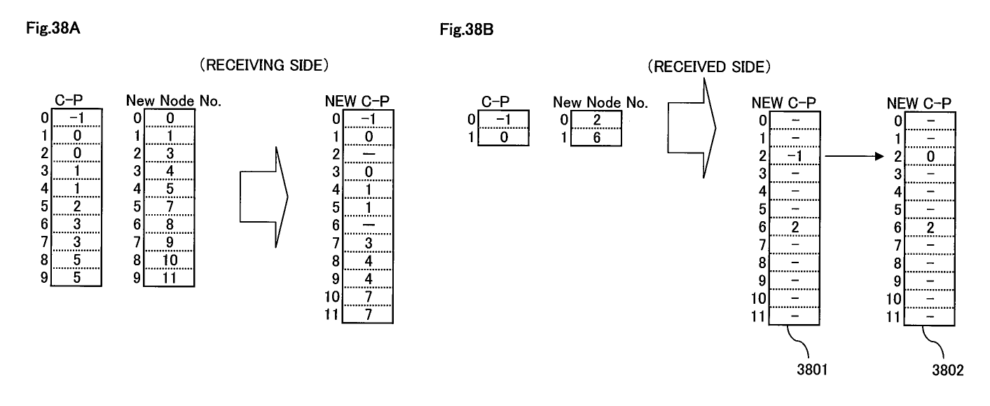

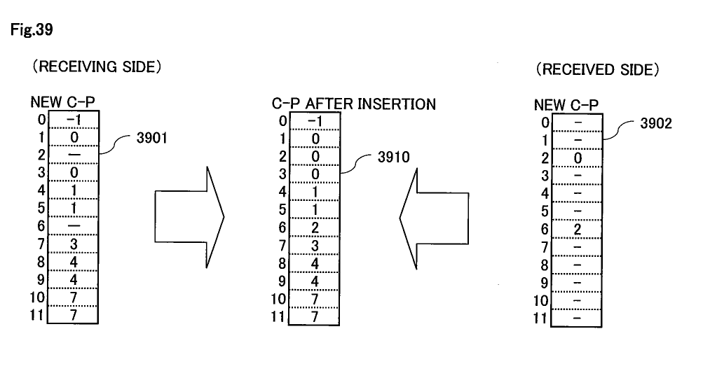

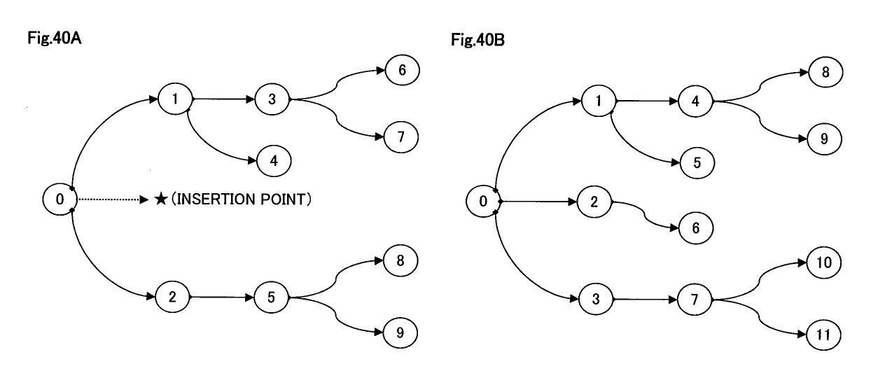

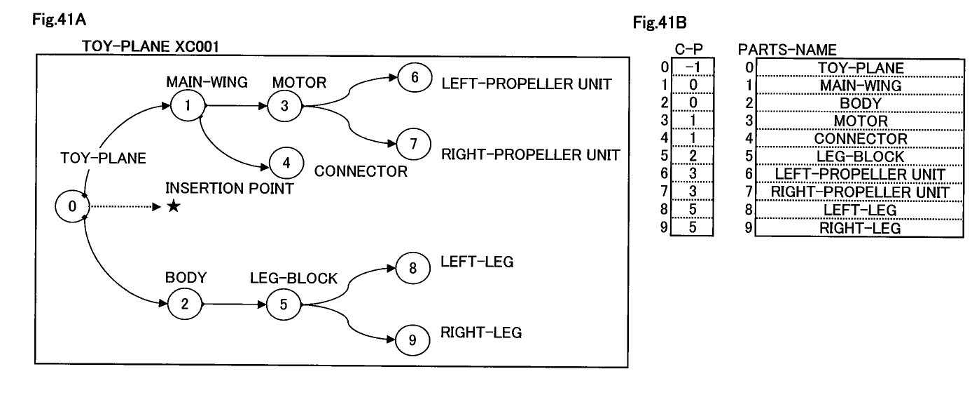

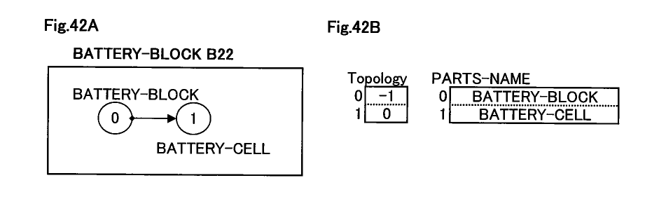

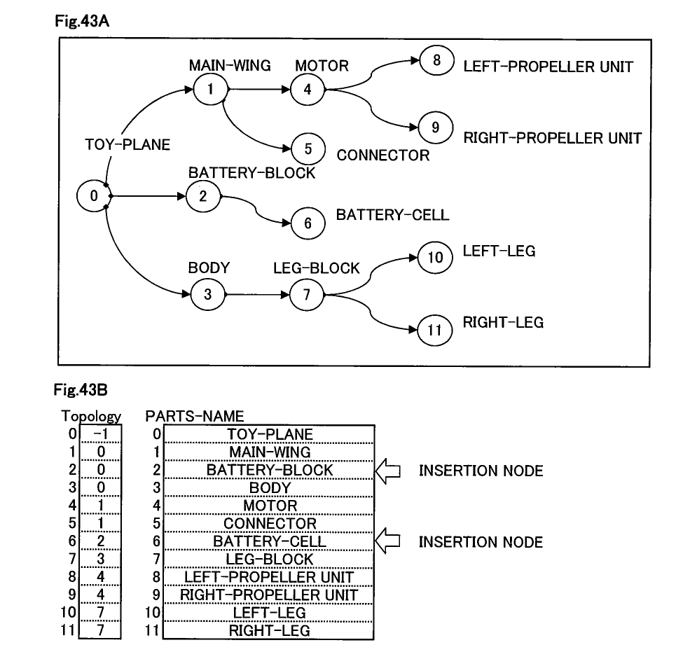

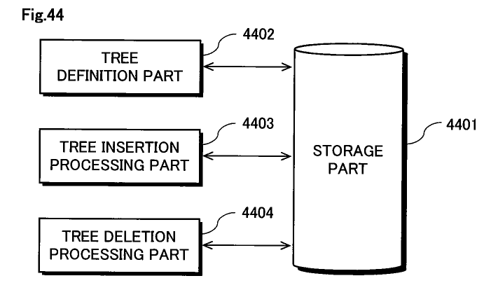

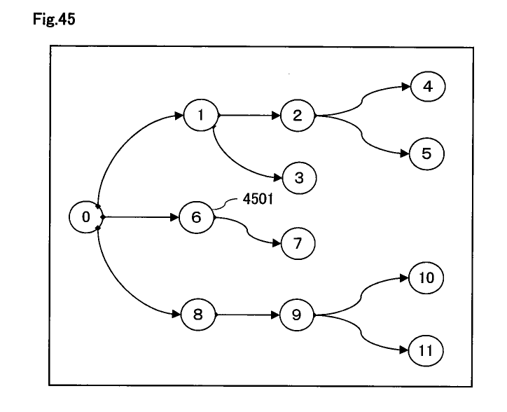

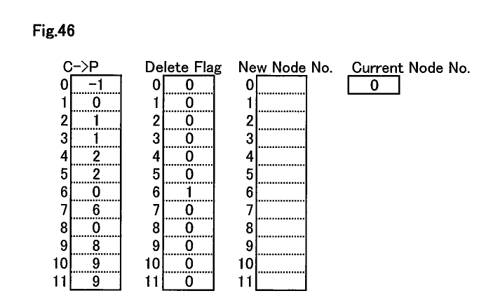

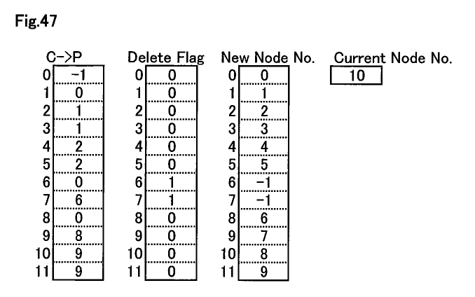

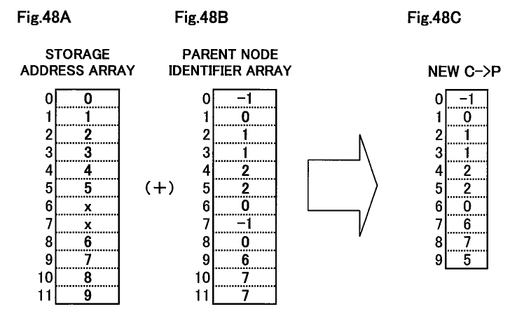

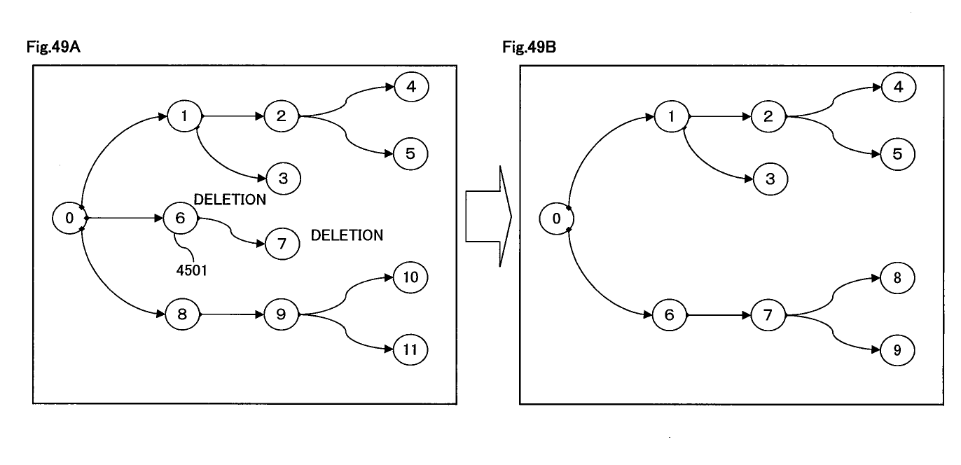

### DESCRIPTION OF REFERENCE NUMERALS

10 information processing device
12 CPU
14 RAM
16 ROM
18 fixed storage device
20 driver
22 I/F
24 input unit
26 display unit
4400 information processing device
4401 storage part
4402 tree definition part
4403 tree insertion processing part
4404 tree deletion processing part

1. An information processing method of deleting from a first tree a subtree including a specific node and descendant nodes of the specific node in an information processing device including a storage device for storing a parent-child relationship definition array, wherein all nodes forming a tree data structure are assigned unique node identifiers, the node identifiers are consecutive integers assigned to the nodes starting from a root node such that a node identifier assigned to a parent node is smaller than a node identifier assigned to a corresponding child node, and the parent-child relationship definition array contains node identifiers assigned to parent nodes of respective non-root nodes in association with node identifiers assigned to the non-root nodes, the non-root nodes being nodes other than the root node, wherein that the method comprises the steps of:
reading out from the storage device a parent-child relationship definition array for the first tree;
storing a deletion-flag array to which initial values are set in the storage device, and setting flags in the deletion-flag array by referring to a node identifier assigned to the specific node, the parent-child relationship definition array and the deletion-flag array, wherein the flags correspond to the node identifiers assigned to the specific node and the descendant nodes of the specific node;
assigning new node identifiers to all nodes in a second tree that is a result obtained by deleting the subtree from the first tree, and generating a new node identifier array in the storage device, wherein the new node identifier array contains the new node identifiers in association with the node identifiers in the first tree; and
generating a new parent-child relationship definition array for the second tree in the storage device based on the parent-child relationship definition array and the new node identifier array, wherein the new parent-child relationship definition array contains the new node identifiers for the parent nodes in association with the new node identifier for the non-root nodes in the second tree.

2. The information processing method as claimed in claim 1, characterized in that a node value storage array is stored in the storage device, wherein the node value storage array contains at least a node value for the node of the tree in association with each of the node identifiers for the nodes of the tree, and
the method further comprises a step of updating the node value storage array in accordance with a correlation between original node identifiers and the new node identifiers by referring to the new node identifier array.

3. The information processing method as claimed in claim 1, characterized in that a node value storage array is stored in the storage device stores, wherein the node storage array contains at least a node value for the node of the tree in association with each of the node identifiers for the nodes of the original tree, and
the method further comprises a step of generating a new node value storage array by referring to the new node identifier array, wherein the new node value storage array containing the node values in association with the respective new node identifiers in accordance with a correlation between original node identifiers and the new node identifiers.

4. The information processing method as claimed in claim 1, wherein the step of generating the new node identifier array comprises the steps of:
reserving an area for the new node identifier array of the same size as that of the parent-child relationship definition array in the storage device;
reserving a current node identifier area in the storage device, the area temporarily storing the new node identifier, and setting an initial value to the current node identifier area; and
setting a value stored in the current node identifier area to the new node identifier array if determined that a flag in the deletion-flag array is not set by referring to the deletion-flag array and then incrementing the value in the current node identifier area, or otherwise setting an invalid value to the new node identifier array if determined that a flag in the deletion-flag array is set.

5. The information processing method as claimed in claim 1, wherein the step of generating the parent-child relationship definition array after deleting the subtree comprises the steps of:
reserving an area for a storage address array of a same size as that of the parent-child relationship definition array in the storage device;
setting the value in the new node identifier array to the storage address array unless a value located at a storage location in the new node identifier array is determined to be the invalid value by referring to the value, the storage location being the same as that of a value in the parent-child relationship definition array;
reserving an area for a parent node identifier array of the same size as that of the parent-child relationship definition array in the storage device;
setting a value in the new node identifier array to the parent node identifier array at the same location as that of a value in the parent-child relationship definition array by referring to the value in the new node identifier array at a location indicated by the value in the parent-child relationship definition array; and
generating the parent-child relationship definition array for that resultant tree, the array containing the value from the parent node identifier array in association with the value in the storage address array.

6. An information processing method of generating a new parent-child relationship definition array in a storage device in an information processing device by inserting into a first tree a second tree as a group of descendant nodes of a specific node in the first tree to form a third tree, the new parent-child relationship definition array representing a tree data structure of the third tree formed, wherein all nodes forming a tree data structure are assigned unique node identifiers, the node identifiers are consecutive integers assigned to the nodes starting from a root node such that a node identifier assigned to a parent node is smaller than a node identifier assigned to a corresponding child node, and the parent-child relationship definition array contains node identifiers assigned to parent nodes of respective non-root nodes in association with node identifiers assigned to the non-root nodes, the non-root nodes being nodes other than the root node, characterized in that the method comprising the steps of:
reading out from the storage device a first parent-child relationship definition array for the first tree and a second parent-child relationship definition array for the second tree;
specifying, for each generation of the third tree, a node belonging to the first tree, the node being located adjacent to a node belonging to the second tree, by connecting a root node of the second tree to the first node as a specifically ordered child node of the specific node in the first tree, and storing information concerning the specific node belonging to the first tree in the storage device;
assigning a new node identifier to each of all nodes in the third tree starting from a root node by referring to the information concerning the specific node belonging to the first tree stored in the storage device, the new node identifier being a consecutive integer assigned to the node with a higher priority to nodes of same generation over child nodes, and generating a first new node identifier array and a second new node identifier array in the storage device, wherein the first new node identifier array contains the new node identifier assigned to the node in the first tree in association with the node identifier assigned to the node in the first tree and the second new node identifier array contains the new node identifier assigned to the node in the second tree in association with the node identifier assigned to the node in the second tree; and
generating the new parent-child relationship definition array in the storage device by setting the node identifiers for non-root nodes in the third tree to the new parent-child relationship definition array in association with the new node identifiers for the non-root nodes in the third array based on the first and second parent-child relationship definition arrays and the first and second new node identifier arrays.

7. The information processing method as claimed in claim 6, characterized in that a first node value storage array and a second node value storage array are stored in the storage device, the first node value storage array containing at least a node value of a node in the first tree in association with each node identifier for the node in the first tree and the second node value storage array containing at least a node value of a node in the second tree in association with each node identifier for the node in the second tree, and
the method further comprises a step of updating at least one of the first and second node value storage arrays in accordance with a correlation between the node identifiers assigned to the nodes in the first tree and the second tree and the new node identifiers assigned to the nodes in the third array by referring to the first and second new node identifier arrays.

8. The information processing method as claimed in claim 6, characterized in that a first node value storage array and a second node value storage array are stored in the storage device, the first node value storage array containing at least a node value of a node in the first tree in association with each node identifier for the node in the first tree and the second node value storage array containing at least a node value of a node in the second tree in association with each node identifier for the node in the second tree, and
the method further comprising a step of generating a new node value storage array by referring to the first and second new node identifier arrays, wherein the new node value storage array containing the node value in association with each of the new node identifiers in accordance with a correlation between the node identifiers assigned to the nodes in the first tree and the second tree and the new node identifiers assigned to the nodes in the third tree.

9. The information processing method as claimed in claim 6, wherein the step of storing information concerning the specific node belonging to the first tree in the storage device comprises a step of storing values indicating insertion positions in an insertion mark array of the same size as that of the first parent-child relationship definition array based on information concerning a position at which the node in the second tree is inserted, wherein the values are stored in the insertion mark array for nodes including a node located immediately after the position and corresponding descendant nodes.

10. The information processing method as claimed in claim 9, characterized in that the method further comprises the steps of:
generating a first level array in the storage device, the first array containing a level value indicating a depth level of each of the nodes in the first tree from the root node; and
generating a second level array in the storage device by referring to a level value in the first level array corresponding to the insertion position of the root node of the second tree, the second level array containing a level value indicating the depth level of each of the nodes in the second tree from the root node of the first tree;
wherein the step of generating the first and second new node identifier arrays comprises the steps of:
reserving areas for the first and second new node identifier arrays being of the same size as those of the first and second parent-child relationship definition arrays, respectively, in the storage device; and
reserving a current node identifier area in the storage device, the area temporarily storing the new node identifiers, and setting an initial value to the area, and
wherein at positions excluding a position in which a value has been changed to a value indicating that the position is the insertion position in the insertion mark array the method further comprises the steps of:
(a) setting a value in the current node identifier area to the first new node identifier array as a value at any of the positions; and
(b) then incrementing the value in the current node identifier area, and
wherein at the position where a value is changed to the value indicating that the position is the insertion position in the insertion mark array the method further comprises the steps of:
(a) referring to the level value in the first level array at the position, and specifying a range within the second level array including the same level value as that of the first level array;
(b) setting the value in the current node identifier area to the second new node identifier array sequentially from a top of the range;
(c) then incrementing the value in the current node identifier area;
(d) setting the value in the current node identifier area to the first new node identifier array, once values within the range in the second new node identifier array has been set; and
(e) then incrementing the value in the current node identifier area.

11. The information processing method as claimed in claim 6, wherein the step of generating the new parent-child relationship definition array comprises the steps of:
reserving areas for the first and second parent node identifier arrays, respectively, of at least the same size as that of the new parent-child relationship definition array in the storage device;
converting node identifiers for a child node and corresponding parent node, which are associated with each other by the fist parent-child relationship definition array, into new node identifiers for the child node and corresponding parent node using the first new node identifier array;
setting the new node identifier for the parent node to the first parent node identifier array at a position corresponding to a value of the new node identifier of the child node;
converting node identifiers for a child node and corresponding parent node, which are associated with each other by the second parent-child relationship definition array, into new node identifiers for the child node and corresponding parent node using the second new node identifier array;
setting the new node identifier for the parent node to the second parent node identifier array at a position corresponding to a value of the new node identifier of the child node; and
generating the new parent-child relationship definition array by superposing the first parent node identifier array and the second parent node identifier array.

12. An information processing device configured to delete from a first tree a subtree including a specific node and descendant nodes of the specific node, the information processing device including a storage device for storing a parent-child relationship definition array, wherein all nodes forming a tree data structure are assigned unique node identifiers, the node identifiers are consecutive integers assigned to the nodes starting from a root node such that a node identifier assigned to a parent node is smaller than a node identifier assigned to a corresponding child node, and the parent-child relationship definition array contains node identifiers assigned to parent nodes of respective non-root nodes in association with node identifiers assigned to the non-root nodes, the non-root nodes being nodes other than the root node, wherein the information processing device comprises:
a data reading means to read out from the storage device a parent-child relationship definition array for the first tree;
a deletion-flag setting means to store a deletion-flag array to which initial values are set in the storage device, and set flags in the deletion-flag array by referring to a node identifier assigned to the specific node, the parent-child relationship definition array and the deletion-flag array, wherein the flags correspond to the node identifiers assigned to the specific node and the descendant nodes of the specific node;
a new node identifier array generating means to assign new node identifiers to all nodes in a second tree that is a result obtained by deleting the subtree from the first tree, and generate a new node identifier array in the storage device, wherein the new node identifier array contains the new node identifiers in association with the node identifiers in the first tree; and
a parent-child relationship definition array generating means to generate a new parent-child relationship definition array for the second tree in the storage device based on the parent-child relationship definition array and the new node identifier array, wherein the new parent-child relationship definition array contains the new node identifiers for the parent nodes being in association with the new node identifier for the non-root nodes in the second tree.

13. The information processing device as claimed in claim 12, characterized in that a node value storage array is stored in the storage device, wherein the node value storage array contains at least a node value for the node of the tree in association with each of the node identifiers for the nodes of the tree, and
the device further comprises a node value storage array updating means to update the node value storage array in accordance with a correlation between original node identifiers and the new node identifiers by referring to the new node identifier array.

14. The information processing device as claimed in claim 12, characterized in that a node value storage array is stored in the storage device stores, wherein the node storage array contains at least a node value for the node of the tree in association with each of the node identifiers for the nodes of the original tree, and
the device further comprises a node value storage array generating means to generate a new node value storage array by referring to the new node identifier array, wherein the new node value storage array containing the node values in association with the respective new node identifiers in accordance with a correlation between original node identifiers and the new node identifiers.

15. The information processing device as claimed in claim 14, wherein the new node identifier array generating means is configured to:
reserve an area for the new node identifier array of the same size as that of the parent-child relationship definition array in the storage device;
reserve a current node identifier area in the storage device, the area temporarily storing the new node identifier, and setting an initial value to the current node identifier area; and
set a value stored in the current node identifier area to the new node identifier array if determined that a flag in the deletion-flag array is not set by referring to the deletion-flag array and then increment the value in the current node identifier area, or otherwise set an invalid value to the new node identifier array if determined that a flag in the deletion-flag array is set.

16. The information processing device as claimed in claim 12, wherein the post-deletion parent-child relationship generating means is configured to:
reserve an area for a storage address array of a same size as that of the parent-child relationship definition array in the storage device;
set the value in the new node identifier array to the storage address array unless determined that a value located at a storage location in the new node identifier array is the invalid value by referring to the value, the storage location being the same as that of a value in the parent-child relationship definition array;
reserve an area for a parent node identifier array of the same size as that of the parent-child relationship definition array in the storage device;
set a value in the new node identifier array to the parent node identifier array at the same location as that of a value in the parent-child relationship definition array by referring to the value in the new node identifier array at a location indicated by the value in the parent-child relationship definition array; and
generate the parent-child relationship definition array for that resultant tree, the array containing the value from the parent node identifier array in association with the value in the storage address array.

17. An information processing device configured to generate a new parent-child relationship definition array in a storage device included in the information processing device by inserting into a first tree a second tree as a group of descendant nodes of a specific node in the first tree to form a third tree, the new parent-child relationship definition array representing a tree data structure of the third tree formed, wherein all nodes forming a tree data structure are assigned unique node identifiers, the node identifiers are consecutive integers assigned to the nodes starting from a root node such that a node identifier assigned to a parent node is smaller than a node identifier assigned to a corresponding child node, and the parent-child relationship definition array contains node identifiers assigned to parent nodes of respective non-root nodes in association with node identifiers assigned to the non-root nodes, the non-root nodes being nodes other than the root node, wherein the device comprises:
a data reading means to read out from the storage device a first parent-child relationship definition array for the first tree and a second parent-child relationship definition array for the second tree;
a insertion position information generating means to specify, for each generation of the third tree, a node belonging to the first tree, the node being located adjacent to a node belonging to the second tree, by connecting a root node of the second tree to the first node as a specifically ordered child node of the specific node in the first tree, and store information concerning the specific node belonging to the first tree in the storage device;
a new node identifier array generating means to assign a new node identifier to each of all nodes in the third tree starting from a root node by referring to the information concerning the specific node belonging to the first tree stored in the storage device, the new node identifier being a consecutive integer assigned to the node with a higher priority to nodes of same generation over child nodes, and generate a first new node identifier array and a second new node identifier array in the storage device, wherein the first new node identifier array contains the new node identifier assigned to the node in the first tree in association with the node identifier assigned to the node in the first tree and the second new node identifier array contains the new node identifier assigned to the node in the second tree in association with the node identifier assigned to the node in the second tree;
a parent-child relationship definition array generating means to generate the new parent-child relationship definition array in the storage device by setting the node identifiers for non-root nodes in the third tree to the new parent-child relationship definition array in association with the new node identifiers for the non-root nodes in the third array based on the first and second parent-child relationship definition arrays and the first and second new node identifier arrays.

18. The information processing device as claimed in claim 17, characterized in that a first node value storage array and a second node value storage array are stored in the storage device, the first node value storage array containing at least a node value of a node in the first tree in association with each node identifier for the node in the first tree and the second node value storage array containing at least a node value of a node in the second tree in association with each node identifier for the node in the second tree, and
the device further comprises a node value storage array updating means to update at least one of the first and second node value storage arrays in accordance with a correlation between the node identifiers assigned to the nodes in the first tree and the second tree and the new node identifiers assigned to the nodes in the third array by referring to the first and second new node identifier arrays.

19. The information processing device as claimed in claim 17, characterized in that a first node value storage array and a second node value storage array are stored in the storage device, the first node value storage array containing at least a node value of a node in the first tree in association with each node identifier for the node in the first tree and the second node value storage array containing at least a node value of a node in the second tree in association with each node identifier for the node in the second tree, and
the device further comprising a node value storage array generating means to generate a new node value storage array by referring to the first and second new node identifier arrays, wherein the new node value storage array containing the node value in association with each of the new node identifiers in accordance with a correlation between the node identifiers assigned to the nodes in the first tree and the second tree and the new node identifiers assigned to the nodes in the third tree.

20. The information processing device as claimed in claim 17, wherein the insertion position information generating means is configured to store values indicating insertion positions in an insertion mark array of the same size as that of the first parent-child relationship definition array based on information concerning a position at which the node in the second tree is inserted, wherein the values are stored in the insertion mark array for nodes including a node located immediately after the position and corresponding descendant nodes.

21. The information processing device as claimed in claim 20, characterized in that the device further comprises:
a first level array generating means to generate a first level array in the storage device, the first array containing a level value indicating a depth level of each of the nodes in the first tree from the root node; and
a second level array generating means to generate a second level array in the storage device by referring to a level value in the first level array corresponding to the insertion position of the root node of the second tree, the second level array containing a level value indicating the depth level of each of the nodes in the second tree from the root node of the first tree;
wherein the new node identifier generating means is configured to:
reserve areas for the first and second new node identifier arrays being of the same size as those of the first and second parent-child relationship definition arrays, respectively, in the storage device; and
reserve a current node identifier area in the storage device, the area temporarily storing the new node identifiers, and setting an initial value to the area, and
wherein at positions excluding a position in which a value has been changed to a value indicating that the position is the insertion position in the insertion mark array the device is configured to:
(a) set a value in the current node identifier area to the first new node identifier array as a value at any of the positions; and
(b) then increment the value in the current node identifier area, and
wherein at the position where a value is changed to the value indicating that the position is the insertion position in the insertion mark array the device is configured to:
(a) refer to the level value in the first level array at the position, and specify a range within the second level array including the same level value as that of the first level array;
(b) set the value in the current node identifier area to the second new node identifier array sequentially from a top of the range;
(c) then increment the value in the current node identifier area;
(d) set the value in the current node identifier area to the first new node identifier array, once values within the range in the second new node identifier array has been set; and
(e) then increment the value in the current node identifier area.

22. The information processing device as claimed in claim 17, wherein the post-deletion parent-child relationship definition array generating means is configured to:
reserve areas for the first and second parent node identifier arrays, respectively, of at least the same size as that of the new parent-child relationship definition array in the storage device;
convert node identifiers for a child node and corresponding parent node, which are associated with each other by the first parent-child relationship definition array, into new node identifiers for the child node and corresponding parent node using the first new node identifier array;
set the new node identifier for the parent node to the first parent node identifier array at a position corresponding to a value of the new node identifier of the child node;
convert node identifiers for a child node and corresponding parent node, which are associated with each other by the second parent-child relationship definition array, into new node identifiers for the child node and corresponding parent node using the second new node identifier array;
set the new node identifier for the parent node to the second parent node identifier array at a position corresponding to a value of the new node identifier of the child node; and
generate the new parent-child relationship definition array by superposing the first parent node identifier array and the second parent node identifier array.

23. A computer-readable information processing program for deleting from a first tree a subtree including a specific node and descendant nodes of the specific node in a computer including a storage device for storing a parent-child relationship definition array, wherein all nodes forming a tree data structure are assigned unique node identifiers, the node identifiers are consecutive integers assigned to the nodes starting from a root node such that a node identifier assigned to a parent node is smaller than a node identifier assigned to a corresponding child node, and the parent-child relationship definition array contains node identifiers assigned to parent nodes of respective non-root nodes in association with node identifiers assigned to the non-root nodes, the non-root nodes being nodes other than the root node, wherein the program causes the computer to execute the steps of:
reading out from the storage device a parent-child relationship definition array for the first tree;
storing a deletion-flag array to which initial values are set in the storage device, and setting flags in the deletion-flag array by referring to a node identifier assigned to the specific node, the parent-child relationship definition array and the deletion-flag array, wherein the flags correspond to the node identifiers assigned to the specific node and the descendant nodes of the specific node;
assigning new node identifiers to all nodes in a second tree that is a result obtained by deleting the subtree from the first tree, and generating a new node identifier array in the storage device, wherein the new node identifier array contains the new node identifiers in association with the node identifiers in the first tree; and
generating a new parent-child relationship definition array for the second tree in the storage device based on the parent-child relationship definition array and the new node identifier array, wherein the new parent-child relationship definition array contains the new node identifiers for the parent nodes being in association with the new node identifier for the non-root nodes in the second tree.

24. The information processing program as claimed in claim 23, characterized in that a node value storage array is stored in the storage device, wherein the node value storage array contains at least a node value for the node of the tree in association with each of the node identifiers for the nodes of the tree, and
the program further causes the computer to execute a step of updating the node value storage array in accordance with a correlation between original node identifiers and the new node identifiers by referring to the new node identifier array.

25. The information processing program as claimed in claim 23, characterized in that a node value storage array is stored in the storage device stores, wherein the node storage array contains at least a node value for the node of the tree in association with each of the node identifiers for the nodes of the original tree, and
the program further causes the computer to execute a step of generating a new node value storage array by referring to the new node identifier array, wherein the new node value storage array containing the node values in association with the respective new node identifiers in accordance with a correlation between original node identifiers and the new node identifiers.

26. The information processing program as claimed in claim 23, wherein in the step of generating the new node identifier array the program further causes the compute to execute the steps of:
reserving an area for the new node identifier array of the same size as that of the parent-child relationship definition array in the storage device;
reserving a current node identifier area in the storage device, the area temporarily storing the new node identifier, and setting an initial value to the current node identifier area; and
setting a value stored in the current node identifier area to the new node identifier array if determined that a flag in the deletion-flag array is not set by referring to the deletion-flag array and then incrementing the value in the current node identifier area, or otherwise setting an invalid value to the new node identifier array if determined that a flag in the deletion-flag array is set.

27. The information processing program as claimed in claim 23, wherein in that in the step of generating the parent-child relationship definition array after deleting the subtree the program further causes the computer to execute the steps of:
reserving an area for a storage address array of a same size as that of the parent-child relationship definition array in the storage device;
setting the value in the new node identifier array to the storage address array unless a value located at a storage location in the new node identifier array is determined to be the invalid value by referring to the value, the storage location being the same as that of a value in the parent-child relationship definition array;
reserving an area for a parent node identifier array of the same size as that of the parent-child relationship definition array in the storage device;
setting a value in the new node identifier array to the parent node identifier array at the same location as that of a value in the parent-child relationship definition array by referring to the value in the new node identifier array at a location indicated by the value in the parent-child relationship definition array; and
generating the parent-child relationship definition array for that resultant tree, the array containing the value from the parent node identifier array in association with the value in the storage address array.

28. A computer-readable information processing program for generating a new parent-child relationship definition array in a storage device in a computer by inserting into a first tree a second tree as a group of descendant nodes of a specific node in the first tree to form a third tree, the new parent-child relationship definition array representing a tree data structure of the third tree formed, wherein all nodes forming a tree data structure are assigned unique node identifiers, the node identifiers are consecutive integers assigned to the nodes starting from a root node such that a node identifier assigned to a parent node is smaller than a node identifier assigned to a corresponding child node, and the parent-child relationship definition array contains node identifiers assigned to parent nodes of respective non-root nodes in association with node identifiers assigned to the non-root nodes, the non-root nodes being nodes other than the root node, wherein the program causes the computer to execute the steps of:
reading out from the storage device a first parent-child relationship definition array for the first tree and a second parent-child relationship definition array for the second tree;
specifying, for each generation of the third tree, a node belonging to the first tree, the node being located adjacent to a node belonging to the second tree, by connecting a root node of the second tree to the first node as a specifically ordered child node of the specific node in the first tree, and storing information concerning the specific node belonging to the first tree in the storage device;
assigning a new node identifier to each of all nodes in the third tree starting from a root node by referring to the information concerning the specific node belonging to the first tree stored in the storage device, the new node identifier being a consecutive integer assigned to the node with a higher priority to nodes of same generation over child nodes, and generating a first new node identifier array and a second new node identifier array in the storage device, wherein the first new node identifier array contains the new node identifier assigned to the node in the first tree in association with the node identifier assigned to the node in the first tree and the second new node identifier array contains the new node identifier assigned to the node in the second tree in association with the node identifier assigned to the node in the second tree;
generating the new parent-child relationship definition array in the storage device by setting the node identifiers for non-root nodes in the third tree to the new parent-child relationship definition array in association with the new node identifiers for the non-root nodes in the third array based on the first and second parent-child relationship definition arrays and the first and second new node identifier arrays.

29. The information processing program as claimed in claim 28, characterized in that a first node value storage array and a second node value storage array are stored in the storage device, the first node value storage array containing at least a node value of a node in the first tree in association with each node identifier for the node in the first tree and the second node value storage array containing at least a node value of a node in the second tree in association with each node identifier for the node in the second tree, and
the program further causes the computer to execute a step of updating at least one of the first and second node value storage arrays in accordance with a correlation between the node identifiers assigned to the nodes in the first tree and the second tree and the new node identifiers assigned to the nodes in the third array by referring to the first and second new node identifier arrays.

30. The information processing program as claimed in claim 28, characterized in that a first node value storage array and a second node value storage array are stored in the storage device, the first node value storage array containing at least a node value of a node in the first tree in association with each node identifier for the node in the first tree and the second node value storage array containing at least a node value of a node in the second tree in association with each node identifier for the node in the second tree, and
the program further causes the computer to execute a step of generating a new node value storage array by referring to the first and second new node identifier arrays, wherein the new node value storage array containing the node value in association with each of the new node identifiers in accordance with a correlation between the node identifiers assigned to the nodes in the first tree and the second tree and the new node identifiers assigned to the nodes in the third tree.

31. The information processing program as claimed in claim 28, wherein in the step of storing information concerning the specific node belonging to the first tree in the storage device the program causes the computer to execute a step of storing values indicating insertion positions in an insertion mark array of the same size as that of the first parent-child relationship definition array based on information concerning a position at which the node in the second tree is inserted, wherein the values are stored in the insertion mark array for nodes including a node located immediately after the position and corresponding descendant nodes.

32. The information processing program as claimed in claim 31, wherein the program further causes the computer to execute the steps of:
generating a first level array in the storage device, the first array containing a level value indicating a depth level of each of the nodes in the first tree from the root node; and
generating a second level array in the storage device by referring to a level value in the first level array corresponding to the insertion position of the root node of the second tree, the second level array containing a level value indicating the depth level of each of the nodes in the second tree from the root node of the first tree;
wherein in the step of generating the first and second new node identifier arrays the program causes the computer to execute the steps of:
reserving areas for the first and second new node identifier arrays being of the same size as those of the first and second parent-child relationship definition arrays, respectively, in the storage device; and
reserving a current node identifier area in the storage device, the area temporarily storing the new node identifiers, and setting an initial value to the area, and
wherein at positions excluding a position in which a value has been changed to a value indicating that the position is the insertion position in the insertion mark array the program further causes the computer to execute the steps of:
(a) setting a value in the current node identifier area to the first new node identifier array as a value at any of the positions; and
(b) then incrementing the value in the current node identifier area, and
wherein at the position where a value is changed to the value indicating that the position is the insertion position in the insertion mark array the program further causes the computer to execute the steps of:
(a) referring to the level value in the first level array at the position, and specifying a range within the second level array including the same level value as that of the first level array;
(b) setting the value in the current node identifier area to the second new node identifier array sequentially from a top of the range;
(c) then incrementing the value in the current node identifier area;
(d) setting the value in the current node identifier area to the first new node identifier array, once values within the range in the second new node identifier array has been set; and
(e) then incrementing the value in the current node identifier area.

33. The information processing program as claimed in claim 28, wherein in the step of generating the new parent-child relationship definition array the program causes the computer to execute the steps of:
reserving areas for the first and second parent node identifier arrays, respectively, of at least the same size as that of the new parent-child relationship definition array in the storage device;
converting node identifiers for a child node and corresponding parent node, which are associated with each other by the first parent-child relationship definition array, into new node identifiers for the child node and corresponding parent node using the first new node identifier array;
setting the new node identifier for the parent node to the first parent node identifier array at a position corresponding to a value of the new node identifier of the child node;
converting node identifiers for a child node and corresponding parent node, which are associated with each other by the second parent-child relationship definition array, into new node identifiers for the child node and corresponding parent node using the second new node identifier array;
setting the new node identifier for the parent node to the second parent node identifier array at a position corresponding to a value of the new node identifier of the child node; and
generating the new parent-child relationship definition array by superposing the first parent node identifier array and the second parent node identifier array.
